(19) United States
(12) Patent Application Publication
(10) Pub. No.: US 2026/0057471 A1
(43) Pub. Date: Feb. 26, 2026

(54) Memory Shaders

(71) Applicant: NVIDIA Corporation, Santa Clara, CA (US)

(72) Inventors: John Erik LINDHOLM, Saratoga, CA (US); Yury URALSKY, Los Gatos, CA (US)

(21) Appl. No.: 18/811,737

(22) Filed: Aug. 21, 2024

(51) Int. Cl. G06T 1/60; G06T 1/20

(52) U.S. Cl. CPC G06T 1/60; G06T 1/20

(57) ABSTRACT

A programmable atomic memory shader execution circuit is a seamless part of a hierarchical memory system and receives and performs calls to programmable atomic operations from any number of processors. The programmable atomic memory shader execution circuit close to memory allows the execution circuit to access the shader program stored in memory—eliminating latency that would otherwise be involved for an upstream processor to exchange shader instructions, data and memory lock/unlock commands with the execution circuit. The programmable atomic memory shader execution circuit being locked/unlocked (e.g., within an L2 or L3 cache memory) allows the system to quickly lock a memory resource(s), execute one or a number of operations atomically over one or a number of cycles, and then quickly unlock the memory resource.

### CROSS-REFERENCE TO RELATED APPLICATIONS

None.

### FIELD

The technology herein relates to concurrent execution on computing platforms including but not limited to Graphics Processing Units, and more particularly to atomics providing data synchronization between concurrent processes in such systems. Still more particularly, the technology herein relates to Memory Shaders—that is, programs that allow for atomics/critical sections and are an enhancement to atomic units that locklessly perform atomic operations on exclusively reserved resources and are guaranteed to complete and not deadlock. The technology also relates to enabling execution of programmable atomic operations close to memory.

### BACKGROUND & SUMMARY

Democritus, a 5^{th} century BC Greek philosopher, is credited with the theory that all matter is composed of physically indivisible “atoms”—that is, particles that cannot be subdivided. We now know that what physicists call “atoms” are in fact made of even smaller particles such as electrons, protons and neutrons, and that protons and neutrons are in turn made of even smaller particles called “quarks.” Thus, “quarks” and electrons are now known as elemental particles that are indivisible and cannot be split up into smaller particles.

Nevertheless, even though humans have succeeded in “splitting the atom”, in computer science, Democritus' definition of “atom” still holds: “atomic” means “indivisible”. An “atomic operation” is thus an operation the machine executes as a single, indivisible transaction—that is, there is no interleaving between that atomic operation (which can have one or several steps) and any other operation in the middle. For example, in the case of an atomic memory load operation, the load is performed entirely or not at all. The hardware will not permit any other thread, interrupt, context switch or other machine process to break up the atomic operation, and the atomic operation cannot be subdivided from the standpoint of other events or operations running on the machine. See e.g., Collier, Reasoning About Parallel Architectures (Prentice Hall Jan. 1, 1992).

In modern concurrent execution architectures, atomic operations are helpful for data synchronization across multiple execution threads. As an example, consider a thread performing a read-modify-write operation to a memory location. If the operation is not “atomic” and other precautions such as software-based memory locking are not performed, it would be possible for a different thread to change the memory location while the non-atomic operation is “in flight”, e.g., after the first thread's “read” but before the first thread's “write”. An atomic version of the read-modify-write operation in contrast will disallow the second thread from accessing the memory location until after an already-started atomic operation for the first thread completes.

Such “atomic” operations are in fact quite common. Consider electronic cash withdrawal transactions from a joint bank account. Suppose Alice is at the home improvement store purchasing garden tools and Bob at the same time is in the grocery store purchasing groceries. Suppose Bob and Alice work their way to the checkout register at the same time and request payment from their joint bank account at the same moment in time. Instead of processing both payments concurrently, the bank's computer will process and complete one payment request before starting the other—thereby serializing the payment transactions even though they were presented simultaneously. Doing so prevents the bank account from being overdrawn since the bank's computer can—after completing one payment transaction—ensure there are sufficient remaining funds to process the other transaction.

The above illustrates a so-called “critical section”—code running on the computer that uses a resource and which other processes cannot interrupt or interfere with while the critical section is still using the resource and has not yet released it. Often, such critical sections are constructed using explicit software locks that lock the resource for exclusive use by the critical section and then unlocks the resource once the critical section has finished using the resource. Typically, some type of system-provided or operating system (OS)-provided synchronization mechanism (which can be implemented using infrastructure such as barriers) can be used to help manage and enforce the locking and unlocking. However, critical sections even when managed this way can introduce significant latency because program execution is often distant from memory resources the critical section is accessing.

Lock-based programming (where software instructions explicitly arrange for synchronization mechanisms to enforce the lock) is thus commonly used to explicitly control access to memory to ensure synchronization across multiple concurrently-executing processes. But lock-based programming tends to introduce additional overhead, can be difficult to verify and may not necessarily ensure that forward progress will not be impeded by deadlocks where two threads or other processes competing for resources block each other from acquiring all required resources.

Meanwhile, common computer programming languages such as C++ typically provide an atomic operations library (e.g., the std::atomic< > template class of C++) of components for fine-grained atomic operations allowing for lockless concurrent programming that avoids deadlocks. Similar lockless atomic operations are found in other common programming languages such as javascript and Python. Each atomic operation is indivisible with regards to any other operation (including atomic operations) that involves the same object. Such atomic operations are thread-safe and can be expected to be completed once started-which can be helpful to ensure data synchronization between all concurrently executing threads without requiring the programmer(s) to program locks. But often, the set of atomics in such libraries can be limited to specific, relatively simple instructions that may make it difficult to implement more complex applications such as queueing that have a lot of state that needs to be synchronized. See e.g., en.cppreference.com/w/cpp/atomic/atomic & en.cppreference.com/w/c/language/atomic; C17 standard (ISO/IEC 9899:2018): 6.7.2.4 Atomic type specifiers (p: 87); 7.17 Atomics <stdatomic.h> (p: 200-209); C11 standard (ISO/IEC 9899:2011): 6.7.2.4 Atomic type specifiers (p: 121) 7.17 Atomics <stdatomic.h> (p: 273-286).

Note that in some conventional usages, “atomic operation” is contrasted with “reduction operation”, the latter typically storing the result of partial tasks into a private copy of a variable and then merging these private copies into a shared copy. For example, a reduction operator can be used to reduce an array to a single scalar value. However, in the context herein, no distinction is intended between “atomic operation” and “reduction operation” per se. Rather, a reduction operation will be considered “atomic” if the reduction operation provides lockless exclusive access to a memory resource for a duration that the reduction operation is still executing and has not yet finished updating the memory resource. By “lockless” we mean not requiring included explicit software programming instructions within the application program to create a lock (i.e., in lockless systems, the memory resource can still be “locked” but that locking is accomplished without the human programming having to write the locking mechanism and is instead automatically accomplished by the system on behalf of a thread or process calling a specially designated “atomic operation.”)

In the Graphics Processing Unit (GPU) space, CUDA® (Compute Unified Device Architecture) provides a defined set of atomic functions that perform simple read-modify-write atomic operations on one word residing in global or shared memory. See docs.nvidia.com/cuda/cuda-c-programming-guide/index.html #atomic-functions v12.2 at 7.14 (“Atomic Functions”). The atomicity of such simple atomic functions is enforced by GPU hardware mechanisms that are close to or part of memory. See e.g., U.S. Pat. Nos. 11,016,802; 10,032,245; 9,245,371; US20140267334; US20140189260; U.S. Pat. Nos. 8,411,103; 8,135,926; 8,055,856.

Such CUDAR atomic functions include for example load, store and read-modify-write memory access functions, certain arithmetic functions; and certain bitwise functions. In more detail, a current-generation CUDA® atomic function performs a read-modify-write atomic operation on one 32-bit or 64-bit word residing in global or shared memory. For example, atomicAdd( ) reads a word at some address in global or shared memory, adds a number to it, and writes the result back to the same address. The operation is atomic in the sense that it is guaranteed to be performed without interference from other threads. In other words, no other thread can access this address until the operation is complete. If an atomic instruction executed by a warp reads, modifies, and writes to the same location in global memory for more than one of the threads of the warp, each read/modify/write to that location occurs and they are all serialized (although the order in which they occur is or may be undefined.)

In NVIDIA's unified memory architectures, atomic operations may also execute a 64-bit operation at a specified address on a remote node. Such operations atomically read, modify and write the destination address and the system guarantees that operations on this address by other queue pairs (QPs) on the same channel adapter (CA) do not occur between the Read and Write. The scope of the atomicity guarantee may optionally extend to other CPUs and host channel adapters (HCAs). However, execution by a processor remote to the memory resource being locked/unlocked, will typically earn a penalty in terms of corresponding increases in latency.

Looking back across the evolution from one GPU platform to another, NVIDIA's Fermi GPU (2010) added some basic atomic operations, and the initial set of atomic operations supported by CUDA® (2010) (e.g., add, subtract, increment, decrement, bit-wise and, bit-wise or, bit-wise exclusive or, Exchange, Minimum, Maximum, Compare-and-Swap) were relatively simple (see e.g., Balfour, CUDA Threads and Atomics (25 Apr. 2011).

Over time, more atomic operations have been slowly added as well as different formats for the source/destination values. See e.g., US20200081748.

Nevertheless, source formats remain relatively inflexible and the operations remain simplistic.

While the above CUDA®'s atomic operations are helpful and powerful, current atomics are simple and sometimes too specialized for some programming needs—so software locks and associated programming are used for more complex operations. Software locks tend not to scale well to large concurrent thread counts. But adding more atomic operations to the CUDA® repertoire would require new hardware support, which may take years of development time. See e.g., Giroux, “The One-Decade Task: Putting std::atomic in CUDA” (CppCon 2019), youtu.be/VogqOscJYvk.

Moreover, in the GPU context, atomics are generally believed to be slower than typical accesses (loads, stores). For example, it was believed in the past that performance could degrade when many threads attempted to perform atomic operations on a small number of resources. It was also believed that many or all threads on the machine would stall, waiting to perform atomic operations on a single memory location. Many updates to a single value tended to cause serial bottleneck. Programmers were advised to create a hierarchy of values to introduce more parallelism and locality into their algorithms, but that even when doing so, performance could still be slow so that the programmers were also told to use atomics judiciously. See Balfour, CUDA Threads and Atomics CME343/ME339|25 Apr. 2011, mc.stanford.edu/cgi-bin/images/3/34/Darve_cme343_cuda_3.pdf.

Others have proposed various solutions to such performance issues. For example, Chou et al, “Deterministic Atomic Buffering,” page 981, 53rd Annual IEEE/ACM International Symposium on Microarchitecture (MICRO) (2020), DOI 10.1109/MICRO50266.2020.00083 proposed implementing special hardware buffers to isolate multiple fused atomics to the same location. See also Anand et al, “A deadlock-free lock-based synchronization for GPUs”, Concurrency and Computation Practice and Experience, Volume 31, Issue 7 (10 Apr. 2019) doi.org/10.1002/cpe.4991.

Meanwhile, there is precedent on the graphics side of GPU operation for enabling a software engineer to specify their own operation in place of or as a complement to other operations embodied in hardware. Before programmable shaders for graphics pipelines were developed, the graphics pipeline functions were defined by hardware. A software engineer could use the hardware-based functions in any combination but was unable to add to those functions because they were all embodied in hardware. Programmable shaders changed that by providing application developers with a programmable fragment processor that is programmed (controlled) by a shader program having a number of program instructions. Such program instructions can be represented in a higher level programming language, and allow a greater range of operations than state-based control logic. See e.g., U.S. Pat. No. 6,809,732.

There is also precedent for providing a specialized processor within the memory hierarchy to enable the memory hierarchy to perform memory operations under control of prestored instructions. See for example U.S. Pat. No. 9,111,368 describing a programmable direct memory access (DMA) processor within L2 cache memory.

### BRIEF DESCRIPTION OF THE DRAWINGS

FIG. 1 is an example system block diagram.

FIG. 2 shows an example memory hierarchy.

FIG. 3 shows many processor cores sharing an L2 cache.

FIGS. 4A-4M are together a flip chart animation showing processor cores accessing a memory shader execution circuit close to memory.

FIGS. 5A-5J are together a flip chart animation showing processor cores accessing a memory shader execution circuit in a pipelined fashion.

FIGS. 6A-6C are together a flip chart animation showing processor cores accessing a memory shader execution circuit at a different level of the memory hierarchy.

FIG. 7 is a block diagram of an example programmable atomic memory shader execution circuit (MSEC).

FIG. 7A shows an example MSEC input packet.

FIG. 7B shows an example MSEC return line packet.

FIG. 7C shows an example MSEC cache line packet.

FIG. 7D shows an example MSEC architecture.

FIG. 8 is a block diagram of an example high level atomic process.

FIG. 9 shows an example MSEC register organization.

FIG. 10 shows an example MSEC instruction set architecture (ISA).

FIG. 11 shows a first programming example.

FIG. 12 shows a second programming example.

FIGS. 13 & 13A show a third programming example.

FIGS. 14, 14A & 14B show a fourth programming example.

FIGS. 15-22 show an example non-limiting computing environment.

### DETAILED DESCRIPTION OF NON-LIMITING EMBODIMENTS

Conventional wisdom that atomics ought to be used only judiciously to avoid performance decreases appears to be on the brink of being outdated or inapplicable. Global memory atomic operations have dramatically higher throughput on GPU devices of modern compute capability 3.x than on previous architectures. Furthermore, although algorithms requiring multiple threads to update the same location in memory concurrently have at times on earlier GPUs resorted to complex data rearrangements in order to minimize the number of atomics, many atomics can be performed on devices of compute capability 3.x nearly as quickly as memory loads given improvements in global memory atomic performance. These considerations open a path for simplifying implementations requiring atomicity and/or enable algorithms previously deemed impractical. With performance issues mostly resolved, the path is clear to use atomics in a much wider range of use cases. For example, expanding the scope of atomics beyond fixed, single-cycle functions could make atomics far more useful for a much wider range of applications.

Yet, as discussed above, an additional challenge relates to providing support for such new atomic operations. As discussed above, atomics are typically implemented by hardware circuits that are part of the memory system and are triggered by simple commands from a processor. Because hardware modifications can be costly and time-consuming to develop, there must generally speaking be a clear consensus or identified need before making such hardware modifications. Furthermore, because the modifications are to be embodied in hardware circuits on a chip, the functionality even modified hardware provides is fixed and not expandable. There is generally no flexibility on the part of a software developer to change the way the hardware works—it does what it does, and the software developer's “bricolage” challenge is to use the atomics already built into the hardware to achieve functionality the software developer wants to achieve.

Now suppose a computing platform could enable a software developer to specify their own specialized atomics case-by-case without the need for hardware updates to reflect each new atomic. The atomic operations could be defined by code a software engineer could flexibly write and change using a high level language and a compiler. Such code would be loadable into the computing platform and execution would be accomplished by a call from an application program. Once called, the memory system would execute the operation while protecting it as “atomic”—e.g., non-interruptible once started, either completes or does not execute at all, and the memory or other resource the operation accesses is locked for exclusive use of that atomic operation once the atomic operation begins using it and is released only when the atomic operation has finished using it. Programs could thus encode/emulate future atomics.

### Programmable Memory Shaders

Example technology herein reformulates the previous programmable shader concept to provide a new concept of a “memory shader”—e.g., software configured to be executed by a programmable atomic memory shader execution circuit (MSEC)—which may include a simple programmable processor and associated logic and storage—that is, an embedded circuit which receives and generates signals and performs calls to programmable atomic operations from any number of other processors. Placing the programmable atomic memory shader execution circuit close to memory allows the MSEC to access the shader program stored in memory—eliminating latency that would otherwise be introduced for an upstream processor to exchange shader instructions, data and memory lock/unlock commands with the execution circuit. Furthermore, a programmable atomic memory shader execution circuit that is close to the memory resource being locked/unlocked (e.g., within an L2 or L3 cache memory) allows the system to quickly lock a memory resource(s), execute a critical section comprising one or a number of operations atomically over one or a number of cycles, and then quickly unlock the memory resource-reducing the chance other processes competing for access to the memory resource will stall or block waiting for the critical section to complete execution. Avoiding such stalling/blocking can substantially increase performance of a GPU that may be running hundreds of thousands of threads concurrently.

In one example, a memory shader consists of software instructions—allowing for execution of any number of different programs written by system developers and application developers. However, in example embodiments, such memory shaders do not need to explicitly provide memory location locking and unlocking instructions because those functions can be taken care of instead by hardware associated with the MSEC that executes the memory shader. Complex math atomics become easy to code with such implementations. Moreover, future atomics will likely be more state oriented rather than limited to being simple math oriented. Potential uses of such future atomics include state manipulation applications such as circular queue pointer manipulation and storing associated state. Experience with memory shaders will guide future evolution.

In queueing for example, work is pushed onto a queue and later popped off of the queue. The ability to stitch together queued work provides a flexible and efficient framework for managing workflow. See e.g., US20210294660. However, managing the queue generally benefits from the ability to atomically update the state of the queue in memory. For example, a circular queue is commonly used, with data rotating through a queue of limited size. Pointers such as a head pointer and a tail pointer manage where to write data into the queue and where to read data from the queue. Redundant pointers are sometimes used to hide push and pop latency. Empty and full flags may also be used to help manage the queue.

Maintaining such queue state atomically ensures proper synchronization with other threads and processes. Atomically incrementing a single pointer will generally not be sufficient to manage the queue. Instead, there may be several pointers and flags that must all be atomically updated together as a critical section. If each individual queue state update is atomic but the complete sequence of queue state updates is not atomic, then the overall queue state update could be interrupted or interfered with by another concurrent process.

Preferably, each queue state update may have multiple steps and that collection of steps should be protected by memory access hardware as a lockfree atomic construct (i.e., the equivalent of a critical section that does not require the programmer to explicitly manage locking and unlocking of the resource(s) or object(s) being updated). Thus, queue control could benefit from the ability to stitch together a number of atomic instructions into higher level “critical section” atomic programming constructs but without the need to provide extensive program-side constructs such as managing locking and unlocking that critical sections typically require.

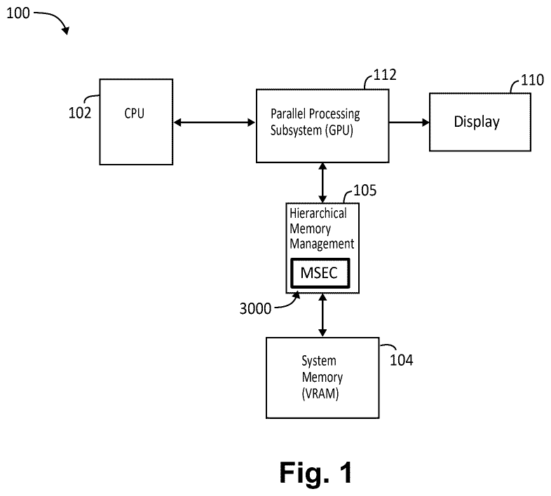

In one embodiment shown in FIG. 1, the memory shader instructions may already reside in memory close to and readily accessible by an MSEC 3000 that executes those instructions. Programs stored in nearby memory are faster to load, reducing latency. Therefore, storing the memory shader programs in memory close to the MSEC that executes the memory shader programs enables much longer programs and more sophisticated operations-thereby accommodating queuing state manipulation as well as a potentially limitless range of other uses and applications.

Memory shaders can thus be used to negate the need for specialized atomics to continually be added to GPU hardware. Memory shaders can enable more complex and richer, more sophisticated programs that are runnable at or close to the memory system in a lockfree manner that will avoid deadlocks (thus providing guaranteed forward progress) and will be guaranteed to run to completion instead of being interrupted by context switching or other events.

### Example Memory Architectures Including MSECs

As shown in FIGS. 1, 2 and 3, in one embodiment, each L2 (level 2 cache memory) bank of a memory hierarchy that supports processing cores such as SMs 2000 has a built-in MSEC 3000 that executes Memory Shaders. MSEC 3000 can be placed in other locations of a memory hierarchy such as shared memory. In particular, while each L2 memory bank is “shared” between multiple processing cores as shown, another type of “shared memory” that is local to the processing cores can provide shared access to multiple processing cores. This latter type of “shared memory” is not functioning as a cache memory (see e.g., U.S. Ser. No. 11/579,925) but rather allows one SM 2000 to read from and write to another SM 2000's local memory. In one embodiment, it is possible to use an MSEC 3000 to perform atomic operations in either (or any other) type of shared memory.

The software call from as upstream processor to the MSEC 3000 may look like a normal SM 2000 or other processing core atomic operation, with an additional shader identifier (ID) that identifies the shader program to be executed. The designated shader program may already reside in a cache memory associated with the MSEC 3000, and the MSEC can retrieve the designated shader program for execution by itself without needing the calling processor to provide it. Large programs can be cached for execution or in some embodiments are made to be small enough to fit into the MSEC 3000. In other embodiments, the calling processor can provide e.g., inline, some or all of the shader program instructions (and/or arguments, operands and/or mode selectors) to the MSEC 3000 for use in executing the memory shader functionality.

The calling thread/processor may for example provide data such as arguments (e.g., up to 256b of data in one embodiment) to be processed by the MSEC 3000 executing the designated shader program. In some embodiments, these arguments may be processed in combination with up to a cache line worth of data from memory. In example embodiments, the target atomic memory shader execution unit MSEC 3000 to perform the operation is selected by the memory address (cache line) of the operation. In such embodiments, the MSEC 3000 does not require any sort of target id that is selected by the calling processor. Rather, each MSEC 3000 has exclusive control of a subset of memory and is the only MSEC that can operate on that particular memory subset.

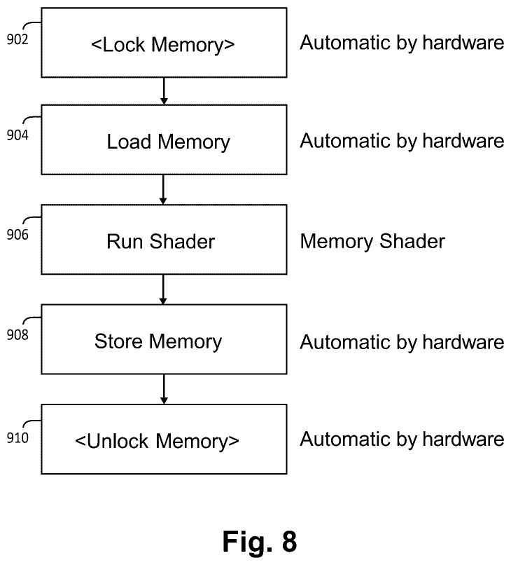

In one embodiment, the MSEC 3000 locates and locks a memory resource(s) to be used or accessed by the memory shader. It then in some embodiments loads a memory area with the memory shader instructions before it atomically executes the memory shader instructions (in other embodiments, the memory shader instructions may already reside in memory and do not need to be loaded again). The MSEC 3000 (which is part of the memory system in this example) then executes the memory shader process without interference from other threads/processes or context switching and updates the already-locked memory resource(s) as needed. When the operation completes, the MSEC 3000 unlocks the memory resource(s) so it can be accessed by other processes/threads, and optionally reports completion status to the calling processor. See FIG. 8.

Example embodiments thus provide programmable atomic/critical sections and synchronization primitives on a highly parallel architecture with an ability to run complex or simple memory shaders close to memory, with hardware-supported locking for extended critical section programming. Shader length is assumed normally short but can be long. Memory shaders allow flexible algorithms. Such technology may be helpful for the future as more state based atomics (e.g., queue pointers, flags, counters) are desired for implementing consumer-producer programming models. Potential uses/advantages also include improved sorting applications such as raytracing divergence mitigation. Potentially, CUDA® and/or compute programming models might expose high-level details in some embodiments Example Shared MSEC Operation

In more detail, FIG. 1 shows an example computing platform architecture comprising a CPU 102, system (VRAM) memory 104, and a parallel processing subsystem 112. The parallel processing subsystem can comprise one or more GPUs including parallel processors (e.g., streaming multiprocessors including processing cores). A hierarchical memory management unit (MMU) 105 provides caching and virtual memory address management and support for low (or hidden) latency access to main memory 104. In one embodiment, the MSEC 3000 is disposed within the MMU 105, for example, in a cache memory within the MMU.

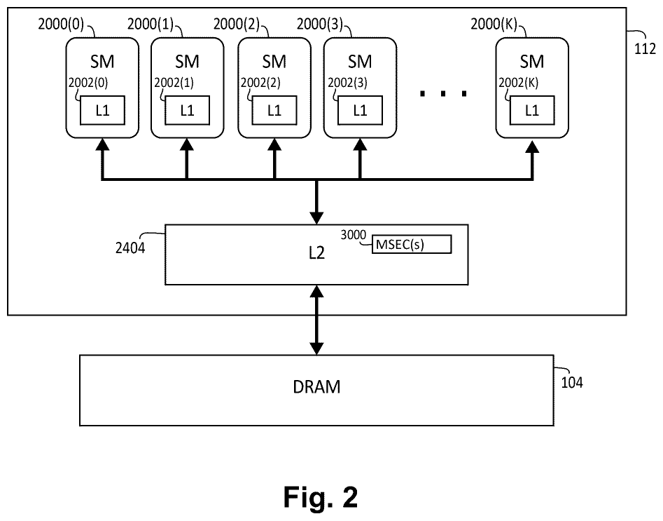

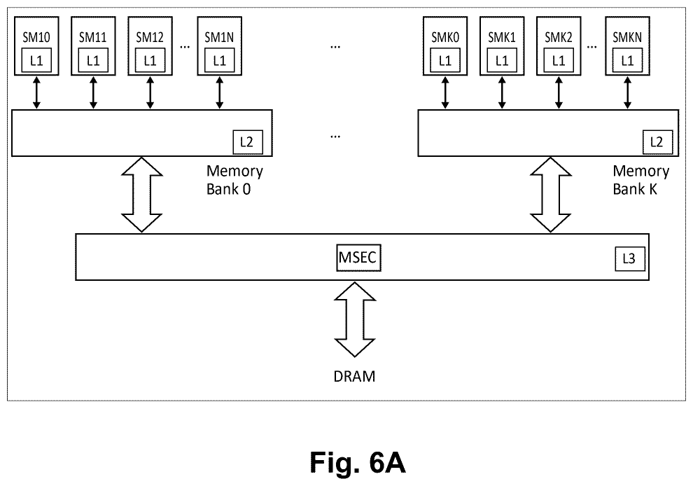

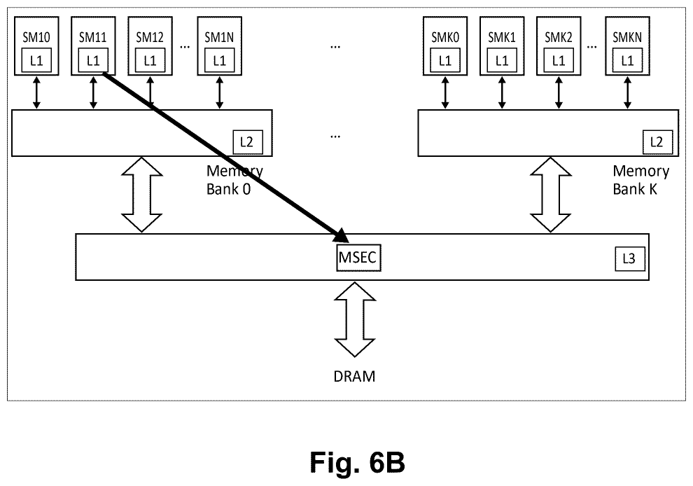

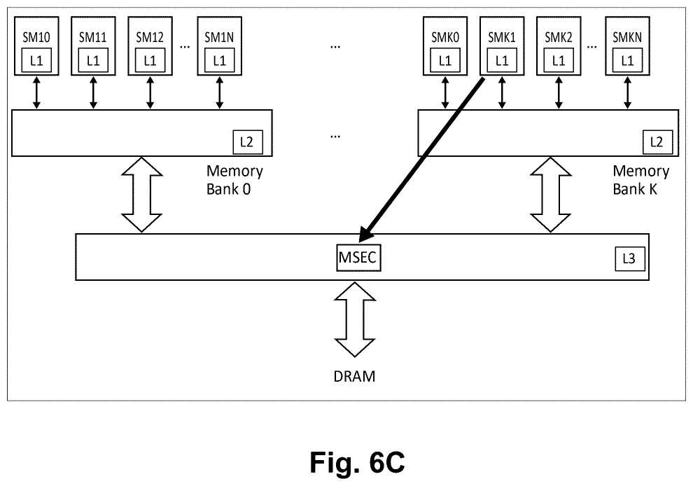

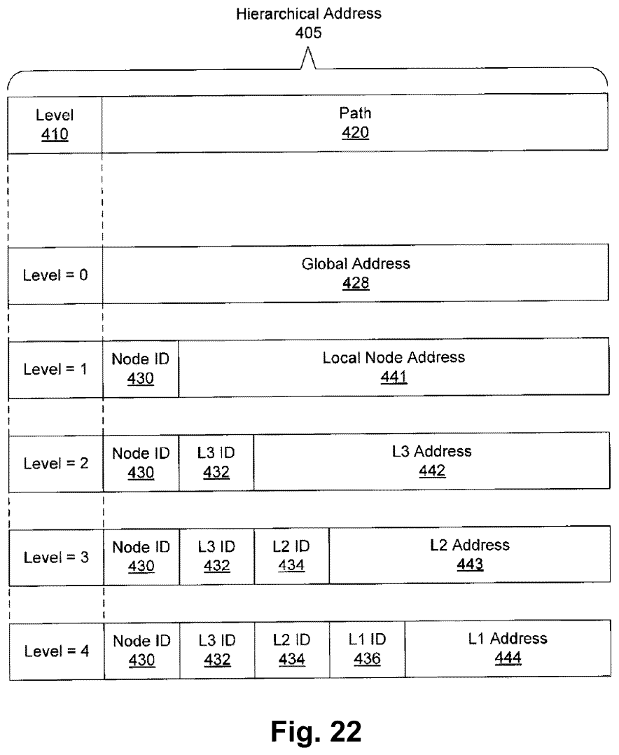

FIG. 2 shows the MSEC 3000 disposed and operating within a MMU L2 cache memory shared by K processors 2000. In this view, each SM 2000 has an L1 cache memory 2002. These L1 cache memories 2002 in turn retrieve from an L2 cache memory and store writes back to the L2 cache memory. There can be many L2 cache memories within the system each serving a respective cluster of such SMs 2000. Each L2 cache memory in turn retrieves from and writes to main memory 104 (which in one embodiment may comprise many VRAM chips arranged in a unitary memory address space). In some embodiments, an additional hierarchical cache memory such as an L3 cache can be interposed between the L2 cache memory and main memory 105 to further reduce and/or hide memory latency (see e.g., FIGS. 6A-6C and FIG. 22).

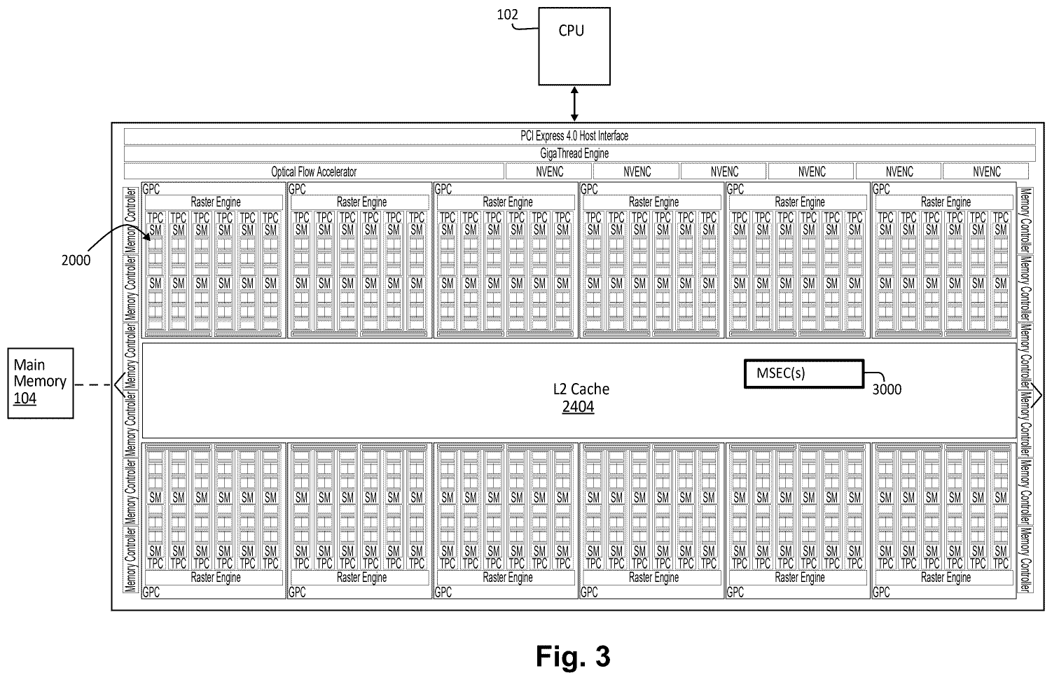

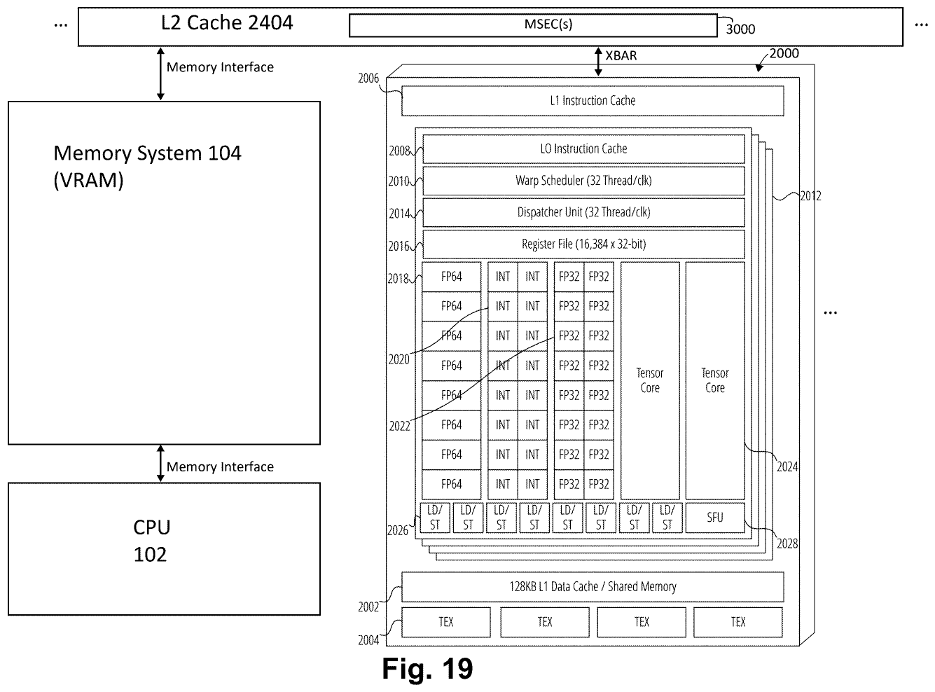

The FIG. 3 embodiment shows an L2 cache memory shared by many (e.g., hundreds of) SM processors 2000. In particular, each “texture processing cluster” (TPC) shown in FIG. 3 comprises multiple SM processors 2000 along with other computation units such as tensor cores (see FIG. 19) (each TPC is able to process texture graphics workloads and also compute workloads in one embodiment). In one embodiment, many such TPCs can share a common L2 cache memory bank having an associated MSEC 3000. In one embodiment, a hierarchical memory level/cache is usually constructed out of multiple banks, and each such bank would optimally contain a MSEC 3000. For example, the L2 might contain 32 banks each with a MSEC unit. These banks would typically be address interleaved for high parallel performance. Any SM processor 2000 connected to the L2 memory bank can use the appropriate MSEC(s) 3000 when executing a thread needing to access a memory resource in an exclusive (atomic) way.

### Example MSEC Usage Scenarios

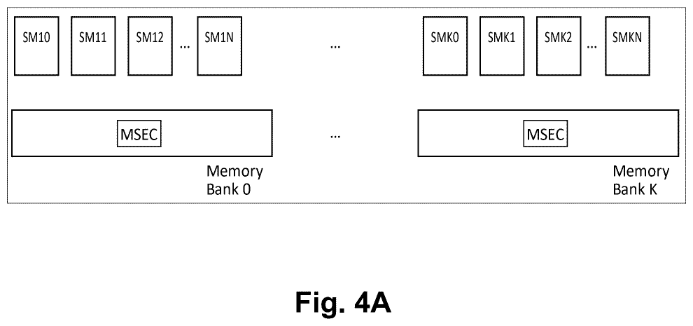

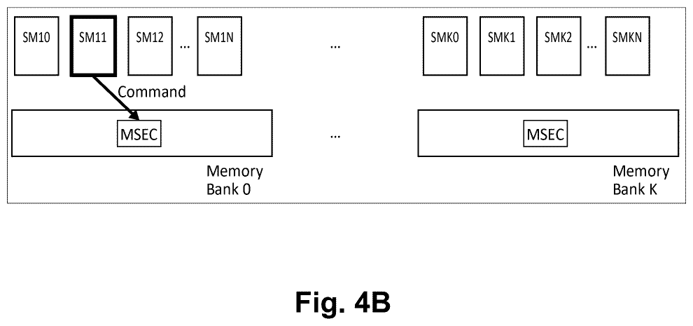

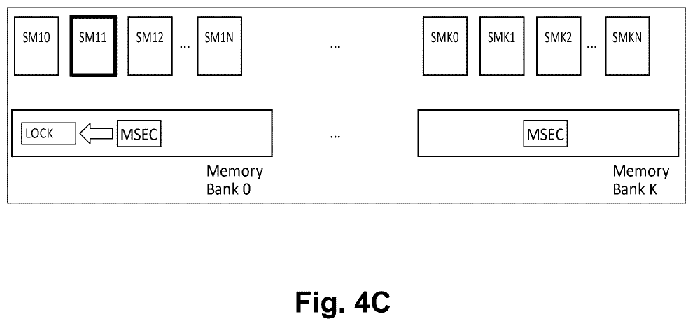

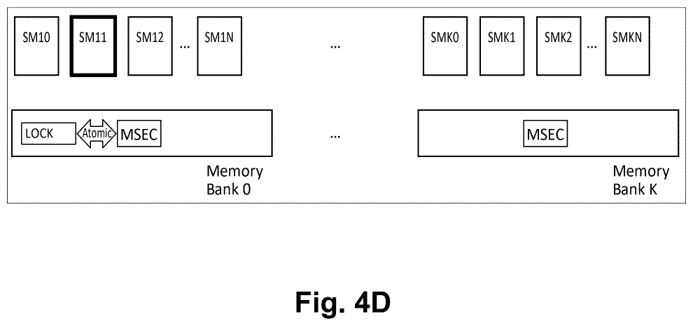

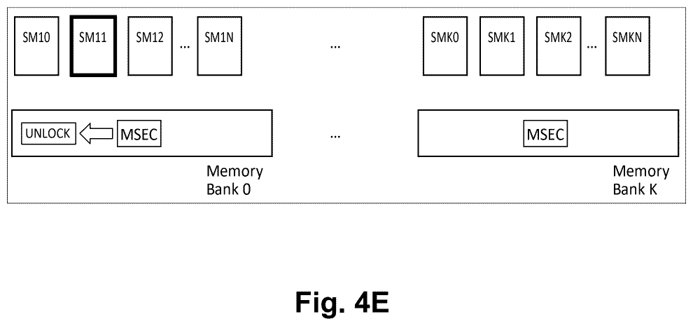

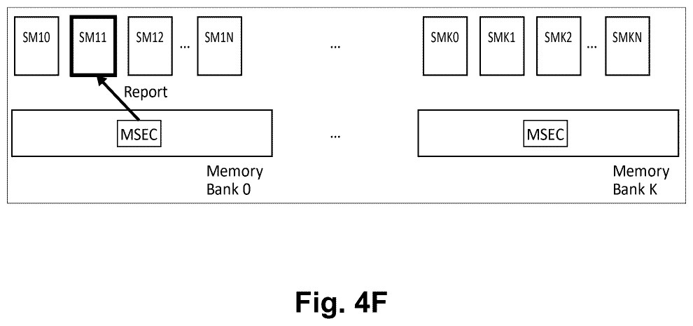

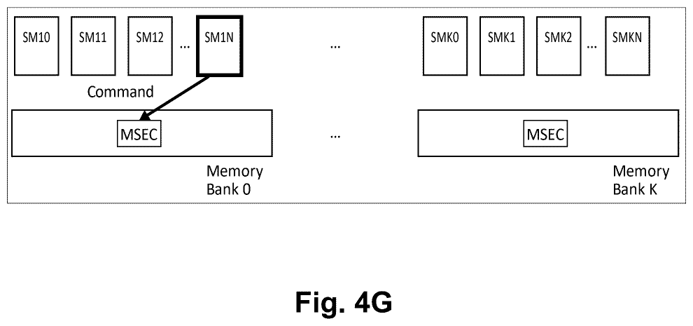

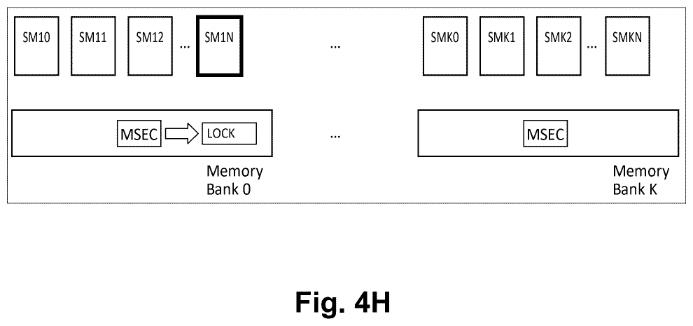

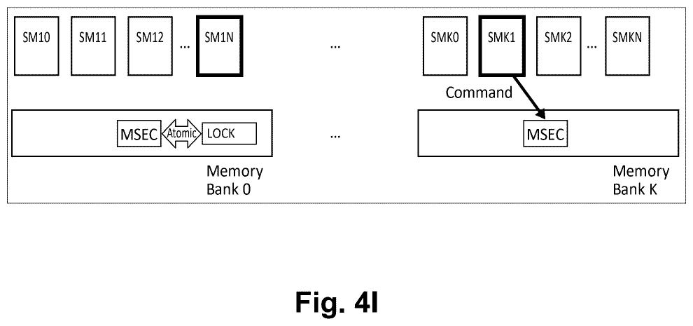

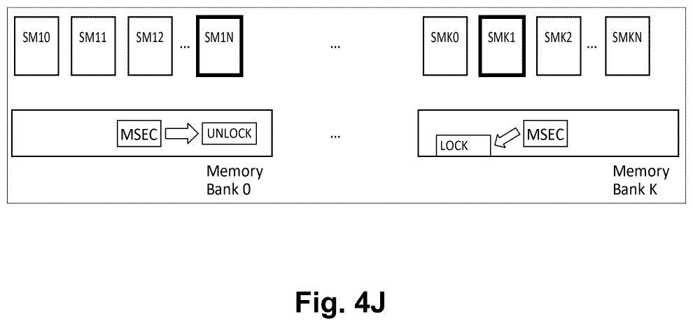

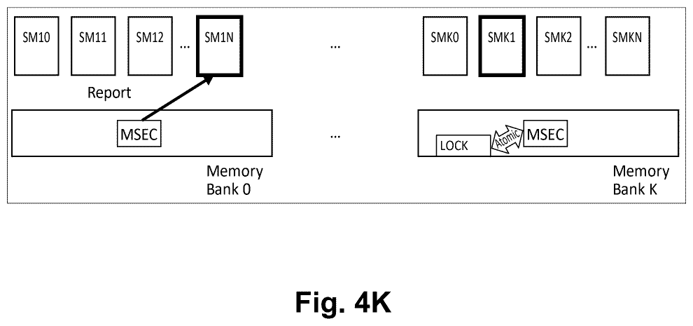

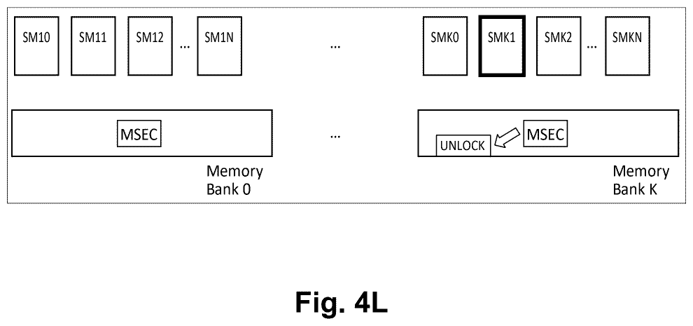

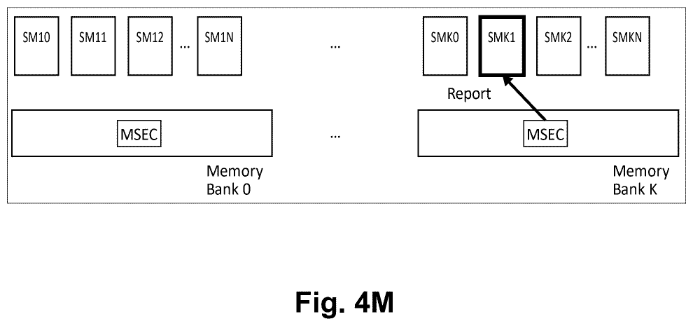

FIGS. 4A-4M are together a flip chart animation that shows how an MSEC can be time-shared among multiple processors. To view this flip chart animation, set the application you are using to view this patent so each figure occupies the full page, and use the page down key to flip from one page to the next. These Figures have been simplified for purposes of illustration since, in some embodiments, any processor SM can access any location in any memory bank (the banks here are assumed to be memory interleaved).

Focusing on the left-hand side of FIGS. 4A-4M, a memory bank 0 such as a cache memory may be shared by a number of processors 2000 such as shown in FIG. 2. Assume that processor SM11 is running a thread that wishes to perform an atomic operation on a particular memory location(s) within memory bank 0. Processor SM11 sends a command to the MSEC 3000 within memory bank 0 specifying a memory shader that has been prestored in memory bank 0 and a memory location/scope for the memory shader to operate on (FIG. 4B). In response, the MSEC 3000 locks the specified memory location(s)/scope(s) to be used or updated by the memory shader (FIG. 4C) and performs a potentially multi-step atomic operation on the locked memory location(s) that the specified memory shader defines (FIG. 4D). When the atomic operation is completed, the MSEC releases the lock (FIG. 4E) and sends a report to the calling processor SM11 (FIG. 4F).

FIG. 4G shows a different processor SMIN running a different thread that wishes to perform the same or different atomic operation on a different memory location(s) within memory bank 0. Processor SMIN sends a command to the MSEC within memory bank 0 specifying a memory shader that has been prestored in memory bank 0 and also specifying the memory location(s)/scope(s) to be operated on (FIG. 4G). In response, the MSEC locks the specified memory location(s)/scope(s) to be used or updated by the memory shader (FIG. 4H) and performs a potentially multi-step atomic operation on the locked memory location(s) the specified memory shader defines (FIG. 4I). When the atomic operation is completed, the MSEC releases the lock (FIG. 4J) and sends a report to the calling processor SMIN (FIG. 4K).

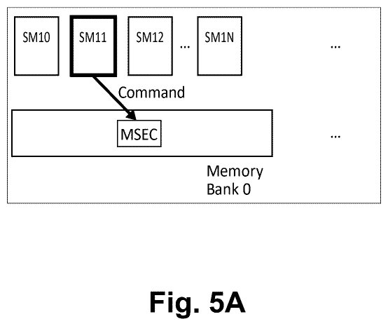

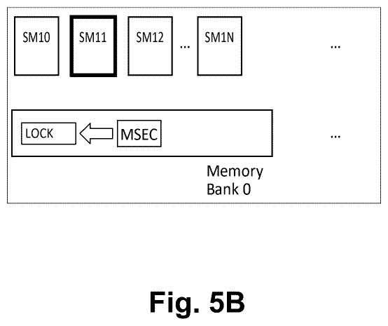

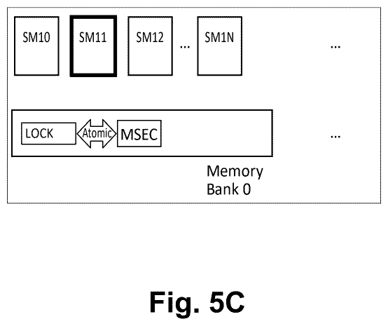

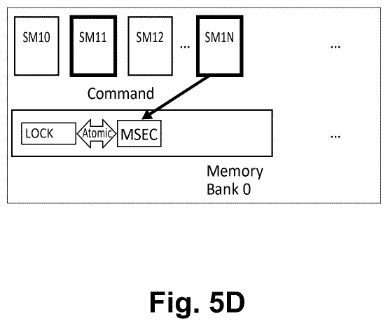

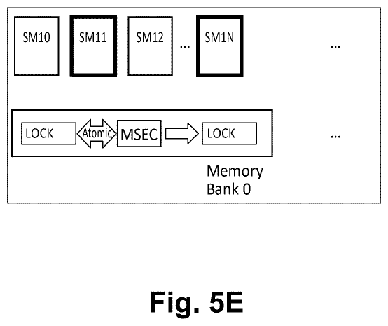

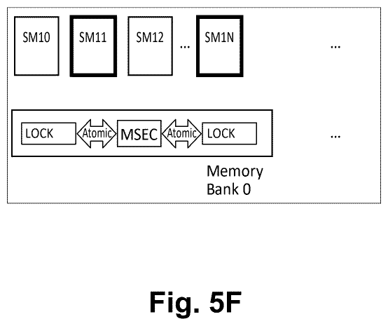

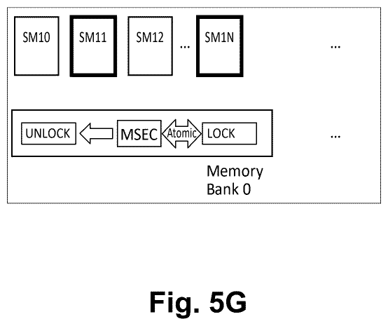

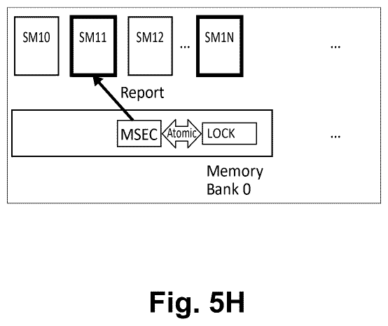

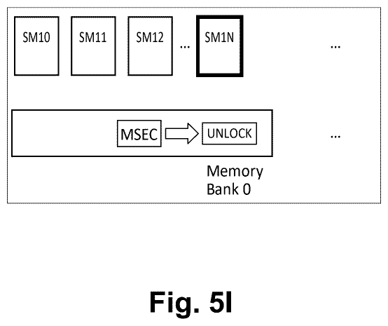

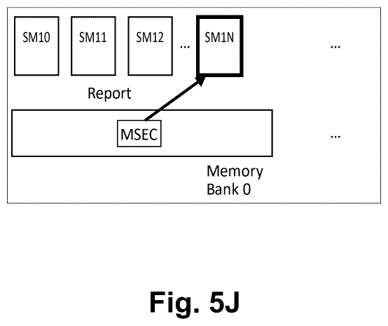

In some embodiments, if the two threads as discussed above wish to lock and operate on different and non-overlapping portions of memory, the MSEC 3000 can pipeline both atomic operations so they can be executed at the same time. See FIGS. 5A-5J for a flip chart animation of that scenario. In example embodiments, a given memory bank generally will not contain multiple MSEC units. There typically is one MSEC unit per bank and multiple banks per memory level/cache. However, a given MSEC unit can be pipelined internally for higher non-conflicting atomic performance. It can also be wider for SIMT style processing. In such embodiment, the operations shown in FIGS. 4B-4F can be performed on memory bank 0 concurrently by a first MSEC (FIGS. 5A-5H) with the memory bank 0 operations shown in FIGS. 4G-4K being performed by the same pipelined MSEC (FIGS. 5D-5J). A routing or scheduling circuit could be used to route an incoming command from a processor to an MSEC for execution. Such routing or scheduling circuit can include a buffering or queuing function so commands received at or near the same time and/or while the MSEC(s) is/are busy performing operations for other threads/processes can be queued until they can be executed in a pipelined fashion. Thus, in one embodiment, a single MSEC can pipeline both (or multiple) atomic operations so long as they don't need to access the same memory locations (the pipelining would enforce memory locking across all thread requests that currently exist as well as across new thread requests that may arise while the atomic operation is being performed). In the case of an overlap in the memory location(s))/scope(s) two threads want to access atomically, the MSEC would delay starting one of the atomic processes until after the other process has completed in order to avoid a collision. See also the optional coalescing mode noted below that allows coalescing of multiple sequential requests into one by hardware if and only if they have the same atomic address (e.g., the same portion of the same cache line), to thereby coalesce received calls specifying the same memory shader and the same memory location(s)/scope(s) into a single atomic operation.

Meanwhile, looking back at the right-hand side of FIGS. 4A-4M, suppose a processor SMK1 connected to a different memory bank K running a different thread wishes to perform the same or different atomic operation on a different memory location(s) within the different memory bank K. In one embodiment, any processor SMK1 can access any bank (here, the banks are assumed to be memory interleaved). Just as described above, processor SMK1 sends a command to the MSEC 3000(K) within memory bank K specifying a memory shader that has been prestored in memory bank K and also specifying a memory location(s)/scope(s) within memory bank K for the specified memory shader to operate on (FIG. 4I). In response, the MSEC 3000(K) within memory bank K locks the specified memory location(s)/scope(s) to be used or updated by the specified memory shader (FIG. 4J) and performs a potentially multi-step atomic operation on the locked memory location(s) as defined by the specified memory shader (FIG. 4K). When the atomic operation is completed, the MSEC 3000(K) releases the lock (FIG. 4L) and sends a report to the calling processor SMK1 (FIG. 4M).

As can be seen in this example, the MSEC 3000(0) within memory bank 0 and the MSEC 3000(K) within memory bank K can perform respective operations concurrently and independently in response to commands received by different threads running on different processors. In one embodiment, each of these memory banks 0 & K is direct mapped (i.e., each memory bank caches a unique set of memory locations with the memory locations one bank caches not overlapping the memory locations another bank caches), so MSECs in different banks do not need to lock each other out of memory locations and communicate with one another to avoid conflict. A single processor might also have different threads of a warp execute atomics in different banks at the same time. Due to xbar timing/scheduling, different threads in different warps from a single processor might also execute atomics in different banks at the same time.

In another embodiment shown in the flip chart animation of FIGS. 6A-6C, an MSEC 3000 may be placed at a different level of a memory hierarchy—in this case within an L3 cache memory that caches data for each of the L2 cache memory banks shown. In the example shown, a first processor connected to a first L2 cache memory bank and a second processor connected to a second cache memory bank can each send atomic commands to an MSEC 3000 disposed in an L3 cache that services both the first L2 memory bank and the second L2 memory bank. In this embodiment, the master copy of the data to be operated on is being served by the target MSEC unit and other cached data copies would be invalidated whereas in other embodiments herein, the master data only is resident in one cache level and is only operated on by MSEC units to avoid such complications. In another embodiment, the MSEC 3000 may be placed in shared memory (e.g., the L1 memory of FIG. 2) local to a processor that other processors and/or threads have shared access to (making atomics helpful). In other embodiments, MSECs may be provided on plural or multiple levels of the memory hierarchy to enable a processor to select which level of the memory hierarchy on which to perform and enforce an atomic operation.

### Example Memory Shader MSEC Architecture

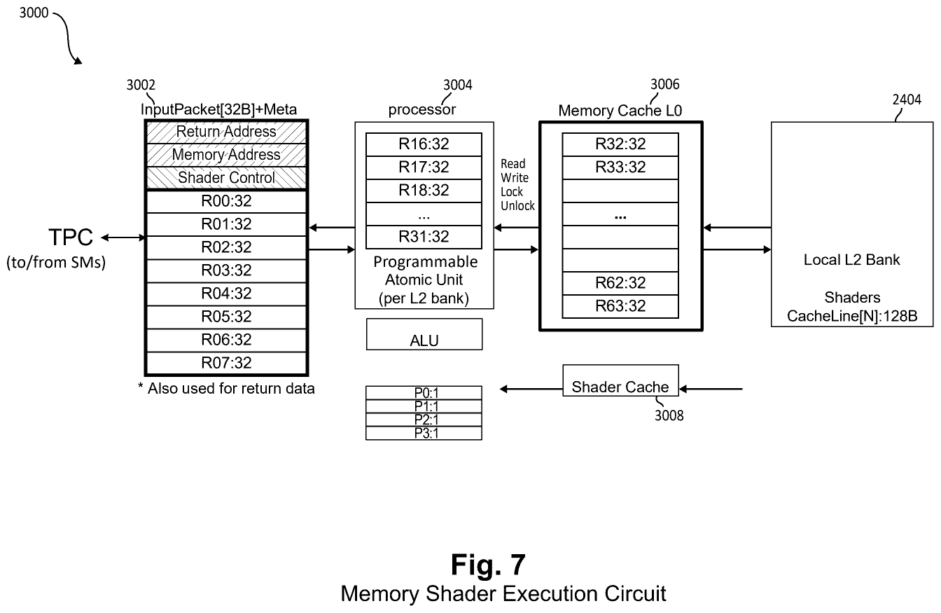

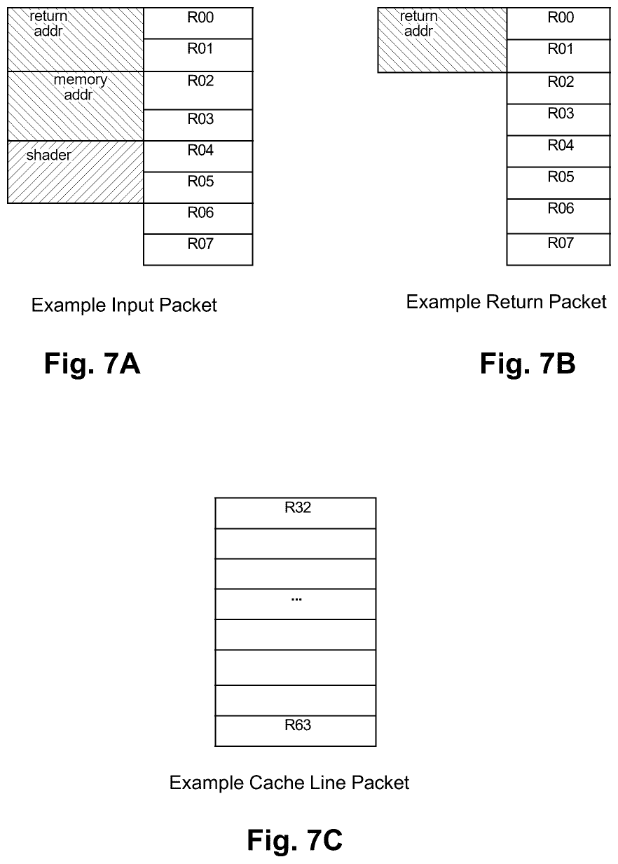

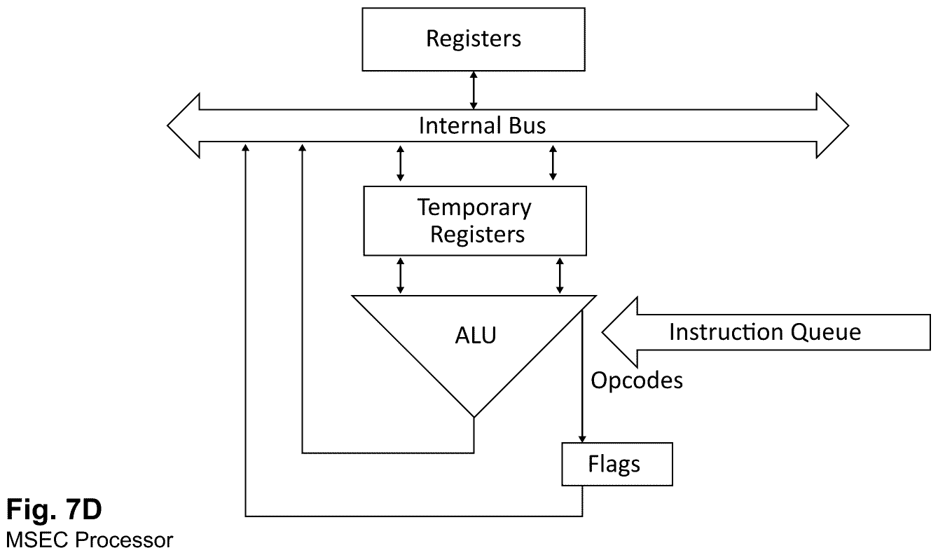

FIG. 7 shows an example MSEC 3000 and associated structure. MSEC 3000 includes an input/return packet store 3002, a programmable processor 3004, a memory cache 3006 and a shader instruction cache 3808. The example MSEC 3000 is connected to and operates on memory locations(s)/scope(s) stored in an L2 cache memory bank 2404 that stores cache lines of e.g., 128 bytes each. The MSEC 3000 can also be called an “atomic unit” or an “atomic execution unit” or an “atomic execution circuit” or an “atomic processor” in that it executes software instructions atomically to perform atomic operations (including reductions). As will become clear from the discussion below, the memory cache 3006 and the shader cache 3008 may or may not be separate from the L2 memory bank 2404, in other words they may actually be part of the L2 cache rather than the MSEC (and the MSEC includes hardware that enables the programmable processor 3004 to access corresponding portions of the L2 memory cache.

### Input/Return Packet Store 3002

In the example shown, the input/return packet store 3002 stores an input packet (see FIG. 7A) provided by the calling processor, for execution by MSEC 3000. After execution by the MSEC 3000, the input packet store may store a return packet (see FIG. 7B) for return to the calling application in the case of atomics (in contrast, so-called reductions generally do not return data to the sender). As shown in FIG. 7A, the input packet in one embodiment includes:
a (read only) return address of the calling processor (e.g., used to return a report to).
a (read only) memory address (e.g., a cache line address that works with an offset and/or mode) specifying a location(s) or scope(s) in memory to lock and execute a specified memory shader program against).
a shader control field (which may contain e.g., the ID of a shader program prestored in the L2 memory bank or elsewhere for the MSEC to execute)
one or a plurality of registers containing arguments or operands the calling processor specifies e.g., as parameters of the specified memory shader.

In one example, a 256b input/return packet size (see FIG. 7A) is mapped to 8 registers R00-R07 used for both input parameters and return parameters (ATOM returns data). In other embodiments, the return packet register mapping can be separate and different from the input packet register mapping, or the two mappings can be partially or completely overlayed.

In one embodiment, a Memory Shader is specified by a 12 bit “shader control” field included with the atomic operation command:
shaderID: 8//shader id
coalesce: 1//allows coalescing of multiple sequential requests into one by hardware if and only if they have the same atomic address
size: 3//locked region size (e.g., variable offset starting from a

specified address to the beginning of a cache line)—see below.

### Memory Shader Storage

In one embodiment, the memory shader specified by the “shader id” field described above is prestored in the L2 cache memory bank where the MSEC resides. To accomplish this in an overall system such as shown in FIG. 5A et seq., each shader needs to be stored in every bank-meaning that the shaders should be stored with knowledge of the memory interleave so that every MSEC in every memory bank has access to every shader. In another embodiment, a custom shader instruction memory could be provided to store the shaders or an additional way to stream the memory shader on demand could be used. Some of these memory shaders could be “standard ones” that are loaded from firmware to memory by the operating or boot system, whereas other memory shaders could be customized software programs supplied by an application program.

In one embodiment, the MSEC 3000 accesses a specified memory shader from its local (e.g., L2) memory bank 2404 bank via an L0 shader cache 3008. Because the MSEC 3000 is constructed to be part of or integrated with the L2 memory bank 2404, retrieval of such memory shader instructions in response to the ID the calling processor specifies in the input packet is low latency.

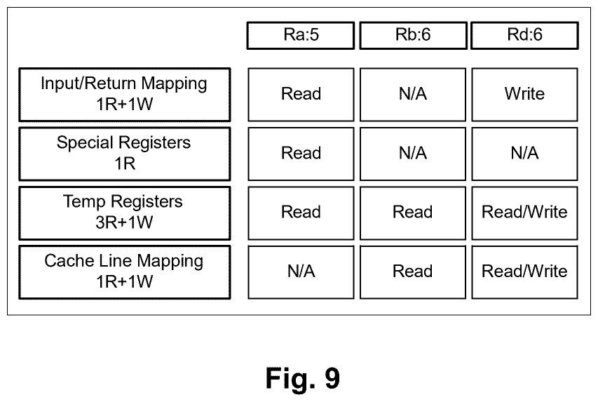

In summary, as shown in the FIG. 9 example showing how registers are mapped, in one embodiment 32b registers may be mapped as follows:
R00-R07: Input/Return Mapping (256b input/return packet)
R08-R15: Special Registers as follows:
   R08: Address offset from input (real atomic address-aligned atomic address)
   R09: #Threads_to_this_address (real atomic address)
   R10: Zero Register (read only)
   R11-R15: UNUSED
R16-R31: Temporary Registers (might only implement 4 or 8 initially or in other embodiments)
R32-R63: Cache Line mapping (assuming a full cache line).

In one embodiment, a 64b register requires an aligned pair.

### Possible Optimizations:

Design for sector instead of cache line. Cheaper basic implementation and/or more concurrent threads.

### Use a LoadSector Opcode to Serialize Access

Support smaller input/return packet size, e.g., 128, 64, 32

### Memory Location/Scope to be Locked and Processed

In one embodiment, the MSEC 3000 operates on a single cache line of data stored in its local L2 cache memory 2404. In an example system, this L2 cache memory uniquely stores this cache line (data block) and no other L2 cache memory in the computing system also stores it. Therefore, in this embodiment, the only way to update that particular part of main memory corresponding to the cache line is to write into that particular L2 cache memory bank, and the MSEC 3000 connected to that memory bank exclusively controls access to that cache line while it is performing an atomic operation on it. Once MSEC 3000 updates the cache line and releases the lock, the cache line can remain resident in the L2 cache memory for other threads and processes to read and access without the latency of a main memory access, or the L2 cache can evict the cache line from the cache memory and write it back into main memory, depending on conditions and the particular caching algorithm(s) in use.

In one embodiment, the “real atomic address” given by the atomic operation is aligned to the size by clearing lower bits. The memory shader just sees the offset above the aligned address. The size is locked and automatically loaded for the shader (see FIG. 8 blocks 902, 904). The size is stored (e.g., depending on the granularity of L2 access, it might be more efficient to update the smaller sector/sub-sector), and unlocked after execution of the shader (see FIG. 8 blocks 908, 910). The size field thus provides a way to flexibly specify a variable amount of memory in the memory bank to lock for this atomic operation being performed. One way to think about this is that the atomic address to be locked includes a low address and a scope or size that defines a sector, chunk or block of memory that is to be locked, atomically operated upon, and unlocked. Some atomic operations might lock only a single word of a cache line, whereas other atomic operations may lock the entire cache line (or more than one cache line in some implementations—although see below). For larger sizes beyond one cache line, however, it is expected in one embodiment that software algorithms will be used. Thus, in one embodiment, an MSEC 3000 can only load/store with its local L2 bank 2404 and only within the size specified. Illegal loads return zero, and illegal stores are ignored.

In one embodiment, the data stored contiguously in L2 cache memory 2404 comprising a single cache line of the cache memory is mapped into registers R32-R63 (128B) of memory cache L0 as shown in FIG. 7C. In one embodiment, the MSEC 3000 thus accesses data organized in a registerized L0 data cache 3006. L0 data cache 3006 thus may comprise a hardware interface into the L2 cache memory that provides a view of cache memory locations that the programmable processor accesses as if they were registers. In the example shown, the MSEC 3000 executes operations on a close copy of a cache line stored in the L2 memory bank 2404, in order to avoid latency associated with executing instructions on faraway registers. One possibility is to load data from L2 memory bank 2404 into the registers of the L0 data cache 3006, operate on the data, and then store the updated data back into the L2 memory bank in a fast way that minimizes latency. Another possibility is to provide a memory overlay “on top of” the L2 memory 2404 (i.e., a memory mapped register file) so the MSEC 3000 can directly operate on data in the L2 memory bank 2404 in place, thus eliminating the time involved to copy the data from the L2 cache to the registers and from registers back to the L2 cache. In the example shown, registers R32, R33, . . . . R63 thus may be overlaid on top of (mapped to) memory storage locations of the L2 memory bank in which the MSEC 3000 resides, giving the MSEC immediate access to registerized memory and simplifying execution. Either way, the programmable processor 3004 can read from and write to these data storage locations as if they are registers, thereby avoiding the need to generate long memory addresses. The L2 cache memory addressing circuits are in one embodiment modified to provide this register view and also to block access by other processes to locations locked by the MSEC. In some embodiments, it may also be useful to load L2 cache data via a LOAD instruction bypassing the register mapping (for example, sequentially traversing a small circular buffer). The cache data would still be loaded as a block from L2, and retired as a block. The register mapping would still work in parallel with this arrangement.

In one embodiment, the basic data memory size pointed to by an MSEC 3000 memory address is assumed to be a cache line of 128B (1024b), divided into 4 sectors of 32B, stored contiguously in one L2 bank 2404 (these specific lengths are arbitrary and can differ from one system to another). In one embodiment, the scope of a memory lock asserted by MSEC 3000 need not be the entire cache line but can instead be some subset of the cache line.

In particular, as to the scope of the lock, the “size” field of the Shader Control data can be used to define a locked region size (e.g., variable offset starting from a specified address to the beginning of a cache line). An example 3-bit encoding is as follows:

| | |
|---|---|
| 0: 16b | // Optional support |
| 1: 32b | // R32 in memory cache valid, R33-R63 reads zero |
| 2: 64b | // R32-R33 in memory cache valid, R34-R63 reads zero |
| 3: 128b | // R32-R35 in memory cache valid, R36-R63 reads zero |
| 4: 256b | // R32-R39 in memory cache valid, R40-R63 reads zero |
| 5: 512b | // R32-R47 in memory cache valid, R48-R63 reads zero |
| 6: 1024b | // R32-R63 in memory cache valid |
| 7: Reserved | // |

Thus, the “size” field can be used to vary the scope of locked memory from one 32-bit word to the entire cache line in several increments (in this case a progressive doubling with each incremental increase). Parts of the cache line that are not locked can be accessed by other processes during the atomic operation.

In one embodiment, the MSEC would track locked regions and simply block further access to such until unlocked. The upstream memory system would back up as required.

In one embodiment, the memory shader program thus finds the content of the memory location in the preinitialized registers and can leave results in the same or different registers which is to be written back to the L2 memory bank upon exit of the memory shader. This avoids the need to perform load-memory-to-register operations and store-register-to-memory operations and also eliminates the need for the MSEC 3000 to use long memory addresses to access data a specified memory shader operates on.

The example embodiments are not limited to a single cache line. In some embodiments, it is possible to lock multiple cache lines so they can all be accessed and updated atomically. Accessing multiple cache lines can be in sequence (one after the other) in one embodiment. However, in one embodiment, the MSEC 3000 is constrained to read from and write to the memory size specified in the atomic operation request so the scope of memory manipulation is limited to the scope of the memory lock the MSEC is enforcing and so delays are not incurred by the need to fetch additional data from main memory. Therefore, a single cache line is preferred in some particular implementations to keep things simple and minimize latency. In one embodiment, due to memory interleave in the L2 banks, each bank does not contain sequential cache lines. Since MSEC units do not communicate with each other, sequential cache lines are difficult. One MSEC could potentially access Memory[x], Memory[x+interleave], Memory[x+2*interleave], etc. . . . , but that would involve interesting app memory alignment beforehand.

### Example MSEC Programmable Processor

In one embodiment, the MSEC programmable processor 3004 comprises temporary registers, an Arithmetic Logic Unit (ALU), predicate flags, an instruction queue and a stack. FIG. 7D shows an example MSEC programmable processor that includes P01, P11, P21, P31 flags that are set based on ALU computation results and can thus provide conditional execution/branching. The ALU can be simple and fast, performing arithmetic and Boolean functions but no complex functions such as tensors, matrix math, etc. On the other hand, nothing prevents the MSEC from having tensor/matrix support or the like, enabling more complex computations to be supported in hardware. A pointer register and an index register may be used to step through instructions in the instruction store and to selectively index the temporary registers, respectively. If present, a simple stack can be used for example to enable recursive execution.

In the particular example shown, the 4 predicates used for conditional execution initialize to TRUE (PT is read-only):
Pred: {!}{PT,P1,P2,P3}
Rp: {PT,P1,P2,P3}

### Example MSEC Instruction Set

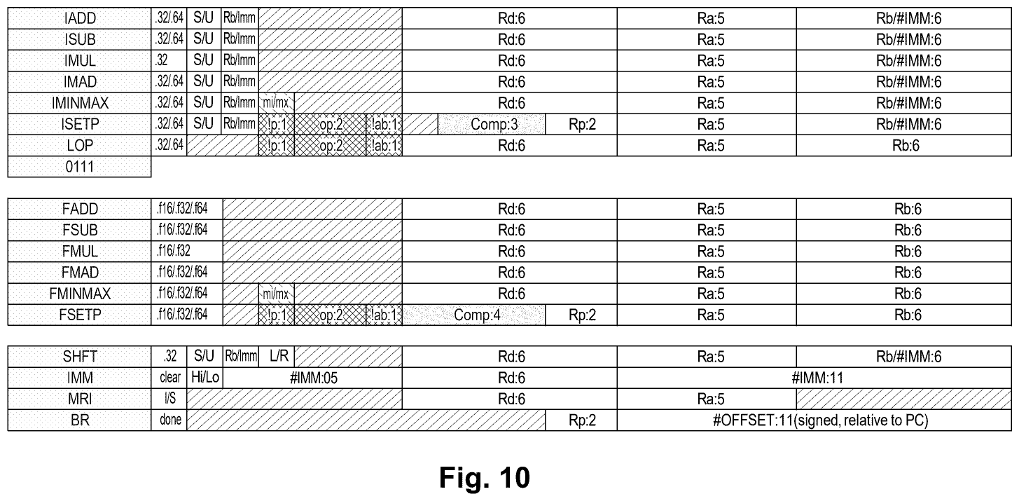

FIG. 10 shows an example instruction set architecture (ISA) for the MSEC including example fields each instruction can operate on. Instruction width is assumed to be 32b in this example. It is possible to use 24b or some other length but it may be simpler fitting an integer number of instructions into a sector, and the space savings of 24b as compared to 32b are not large. A wider encoding also allows more room for future expansion.

The FIG. 10 ISA includes formats for the following sample instructions:

| Op Code | Function/Operation |
|---|---|
| IADD:0000 | Integer Add |
| ISUB:0001 | Integer Subtract |
| IMUL:0010 | Integer Multiply |
| IMAD:0011 | Integer Multiply & Add |
| IMINMAX:0100 | Integer Minimum/Maximum |
| ISETP:0101 | Used to manipulate predicates for predicated |
| | instruction execution |
| LOP:0110 | Logic Operator |
| 0111 | Reserved |
| FADD:1000 | Floating Point Add |
| FSUB:1001 | Floating Point Subtract |
| FMUL:1010 | Floating Point Multiply |
| FMAD:1011 | Floating Point Multiply & Add |
| FMINMAX:1100 | Floating Point Minimum/Maximum |
| FSETP:1101 | Floating-point SET Predicate |
| LD: 1110 | Load To temp register from locked region (a |
| | different temp register plus immediate would be |
| | used for the address) |
| | e.g., LD Rtemp[0], Rtemp[1] + 4 |
| ST: 1111 | Store to locked region from temp register (a |
| | different temp register plus immediate would be |
| | used for the address) |
| | e.g., ST Rtemp[0], Rtemp[1] + 4 |
| SHFT:0000 | Shift |
| IMM:0001 | Immediate Instruction |
| MRI:0010 | sourcing of a rotated input register (R0-R7) into |
| | a temporary register |
| 0011 | Reserved |
| 0100 | Reserved |
| 0101 | Reserved |
| 0110 | Reserved |
| BR:0111 | Branch (allows branching forwards and |
| | backwards) |
| 1*** | Reserved |

In this example instruction set, every instruction has a predicate on the left to make it conditionally execute based on Boolean P flags as described above.

In this example, the “MRI” instruction allows sourcing of a rotated input register (R0-R7) into a temporary register. That is, instead of:

$$Rd = input [ Ra \& 7 ]$$

$$it does$$

$$Rd = input [ ( Ra + input \cdot AddressOffset ) \& 7 ]$$

In one embodiment, BR should only allow backwards branch with compiler approval to avoid infinite loops that could hang the memory system. The compiler could for example allow only branches that can be guaranteed to terminate in a reasonable amount of time.

Other possible instructions include Integer Carry, SIMD/vector operations, 8b/16b integer instructions, bfloat16 or TensorFloat instructions, and Float or Integer instructions. Generally, results of the atomic operation(s) the MSEC performs should be bit-identical to results obtained when an SM performs the same operation(s) itself. This allows flexibility in terms of which processor(s) (MSEC, SM, or both) are performing the operation(s).

### Example I

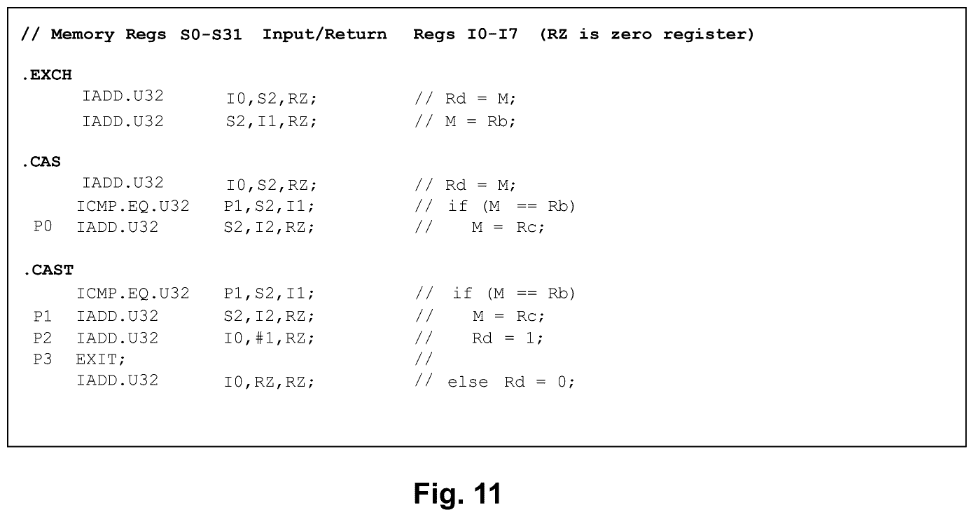

FIG. 11 shows how current CUDA atomic operations can be emulated using the above programmable shader technology and ISA. These atomic operations are simple and each can therefore be emulated by the MSEC programmable processor 3004 using a small number of instructions. The programmable execution circuit may use two or several cycles to perform what the existing hardware can do in a single cycle. The MSEC 3000 could thus be used to replace existing memory hardware that performs existing atomic operations in response to SM. Replacing the existing atomic hardware with a new atomic unit as disclosed herein (and eliminating the previous hardware) instead of adding the new atomic unit to the existing atomic hardware provides simplicity and flexibility commands. Although the MSEC 3000 might not be quite as fast as the existing hardware, it is much more flexible in permitting stitching of previous CUDA commands and providing programmability for a wide variety of new or customized atomic operations. An alternative for some embodiments is to keep previous hardware for fast old-style atomics and add new hardware for flexibility.

### Example II

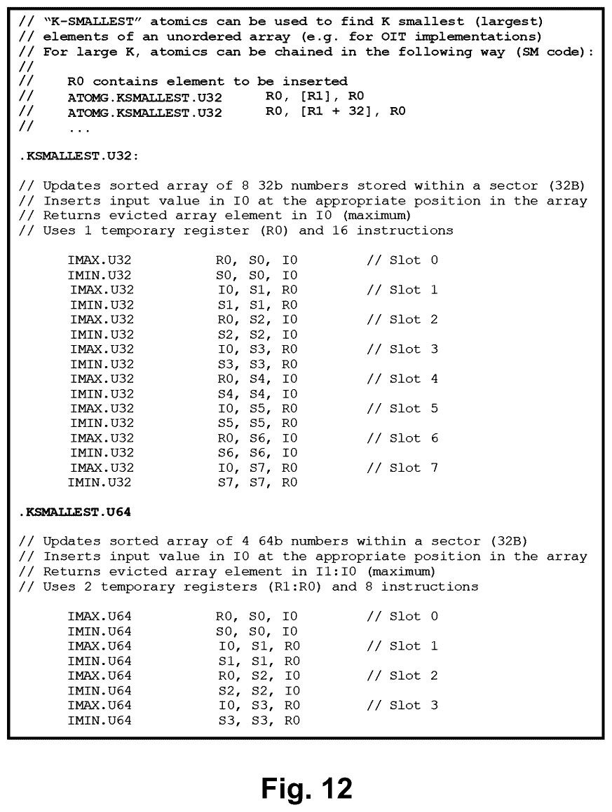

FIG. 12 shows an example newly defined memory shader based atomic operation (“K-Smallest”) that can be used to find K smallest or largest elements of an unordered array. FIG. 12 further shows how multiple calls of this atomic function can be atomically changed together.

### Example III

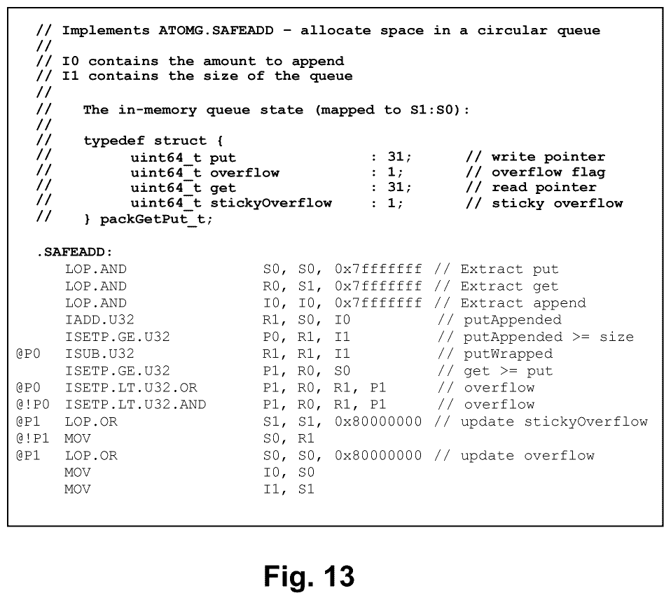

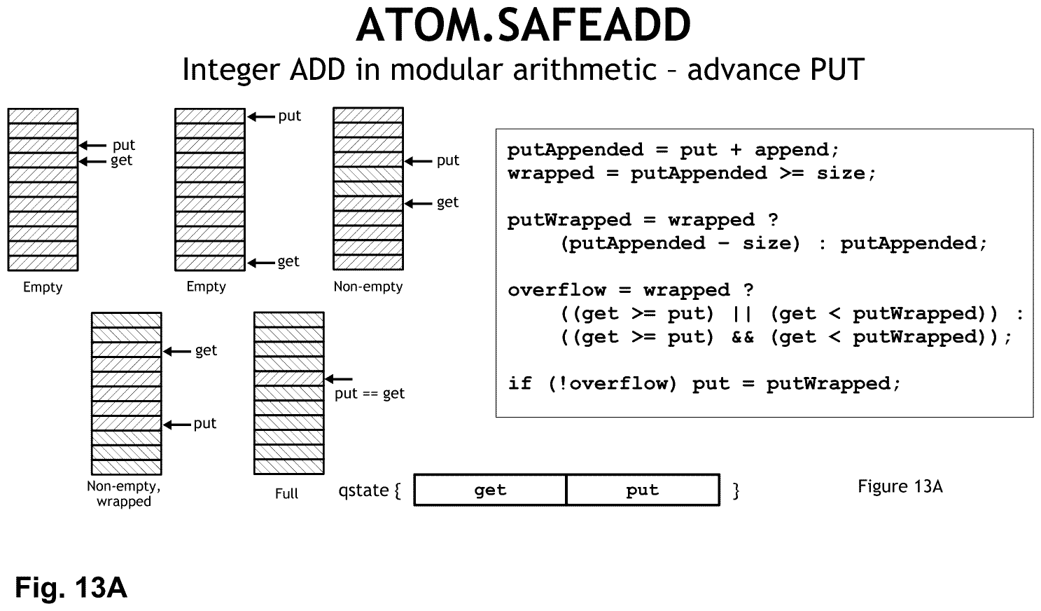

FIG. 13 shows an example “ATOMG.SAFEADD” memory shader based atomic function that allocates space in a circular queue. FIG. 13A shows additional information concerning such an atomic “safe add” providing an Integer ADD in modular arithmetic-advance PUT and how it can be used to manage a queue.

### Example IV

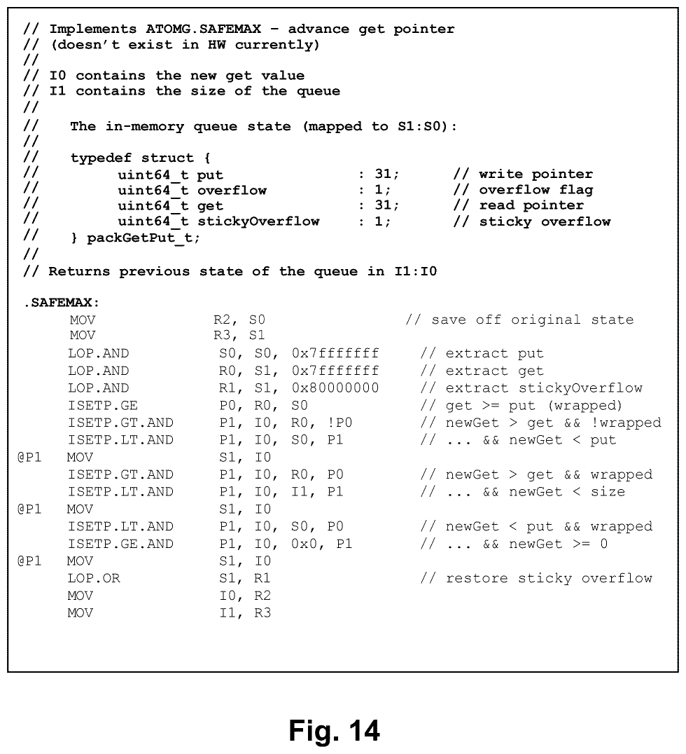

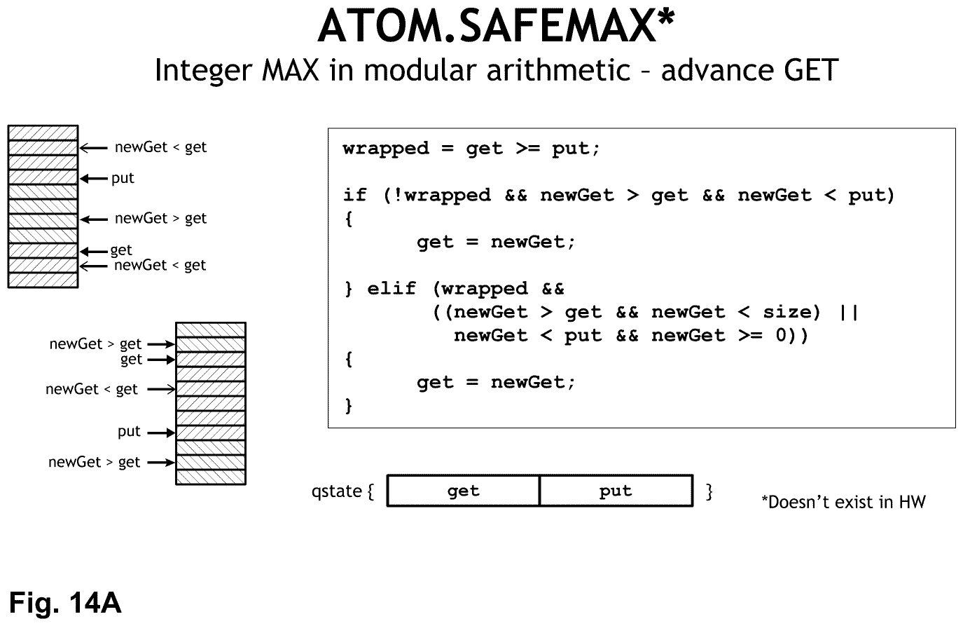

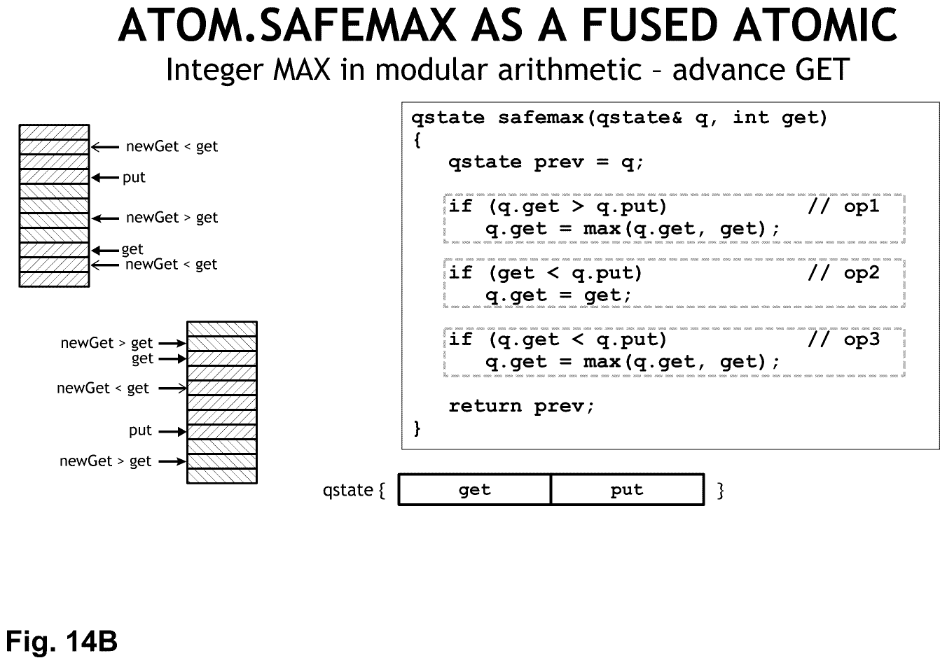

FIG. 14 shows an example “ATOMG.SAFEMAX” memory shader based atomic function that advances a get pointer (this example assumes an instruction set that permits loading of a 32-bit register). FIGS. 14A and 14B show additional information concerning such an atomic “safemax” function and how it can be used to manage a queue.

### Example Hardware Platform/Environment

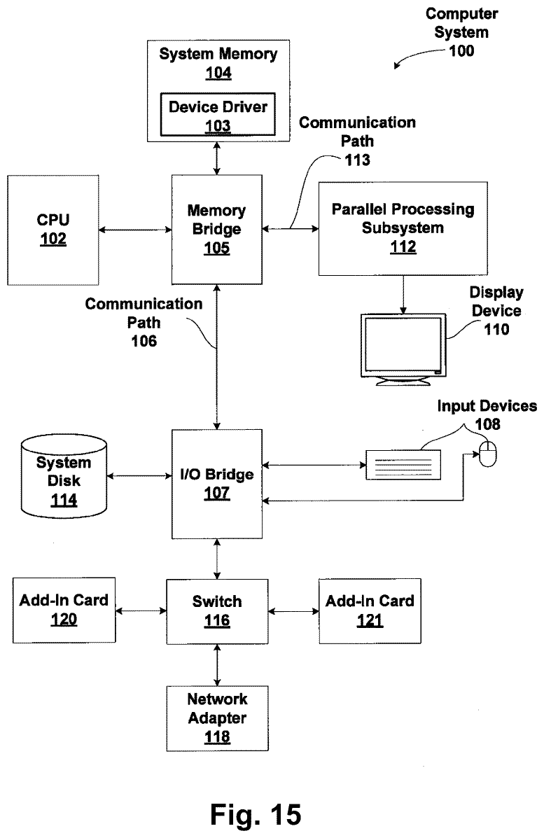

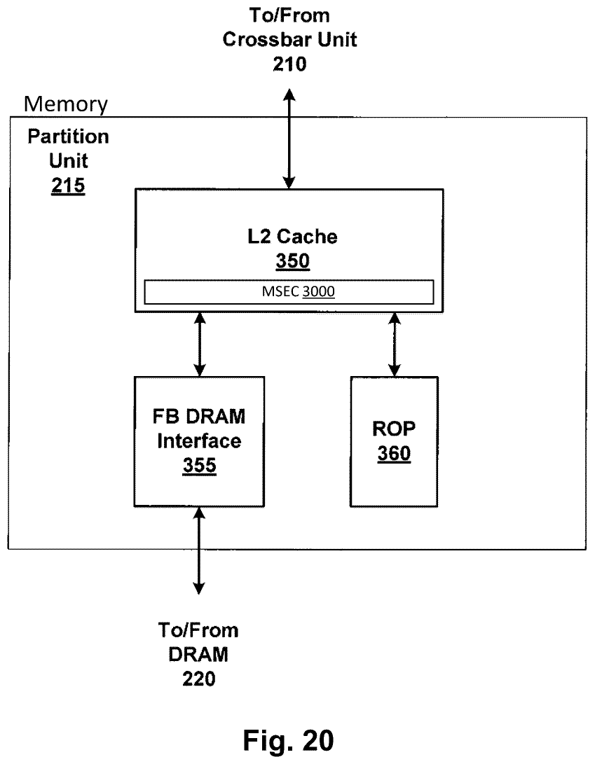

For further context, FIGS. 15-22 show additional non-limiting details of an example computing platform that can benefit from the MSEC 3000.

FIG. 15 shows an expanded, more detailed example of the FIG. 1 system architecture. Additional example components shown in FIG. 15 include a communications path to an I/O bridge 107 providing communications with input devices 108, a disk drive(s) 114, and a switch 116 that in turn communicates with addin cards 120, 121, a network adapter 118 and other components. The parallel processing subsystem 112 is coupled to memory bridge or interconnect 105 via a bus or other communication path 113. In one embodiment, parallel processing subsystem 112 is or includes a graphics subsystem that delivers pixels to a local or remote display device(s) 110.

A system disk 114 is also connected to I/O bridge 107. I/O bridge 107 receives user input from one or more user input devices 108 (e.g., keyboard, mouse) and forwards the input to CPU 102 via path 106 and memory bridge or interconnect 105. Other components (not shown), including USB or other port connections, CD drives, DVD drives, cameras and other image sensors, film recording devices, and the like, may also be connected to I/O bridge 107. Communication paths interconnecting the various components in FIG. 15 may be implemented using any suitable protocols, or any other bus or point-to-point communication protocol(s), and connections between different devices may use different protocols as is known in the art.

In one embodiment, the parallel processing subsystem 112 incorporates circuitry configured for compute processing and graphics and video processing, including, for example, video output circuitry, and comprises at least one graphics processing unit (GPU). In one embodiment, the parallel processing subsystem 112 incorporates circuitry optimized for general purpose processing. In yet another embodiment, the parallel processing subsystem 112 may be integrated with one or more other system elements, such as the memory bridge 105, CPU 102, and I/O bridge 107 to form a system on chip (SoC).

It will be appreciated that the system shown in FIG. 15 is illustrative and that variations and modifications are possible. The connection topology, including the number and arrangement of bridges, the number of CPUs 102, and the number of parallel processing subsystems 112, may be modified as desired. For instance, in some embodiments, system memory 104 is connected to CPU 102 directly rather than through a bridge, and other devices communicate with system memory 104 via memory bridge 105 and CPU 102. In other alternative topologies, parallel processing subsystem 112 is connected to I/O bridge 107 or directly to CPU 102, rather than to memory bridge 105. In still other embodiments, I/O bridge 107 and memory bridge 105 might be integrated into a single chip. Large embodiments may include two or more CPUs 102 and two or more parallel processing systems 112. The particular components shown herein are optional; for instance, any number of add-in cards or peripheral devices might be supported. In some embodiments, switch 116 is eliminated, and network adapter 118 and add-in cards 120, 121 connect directly to I/O bridge 107.

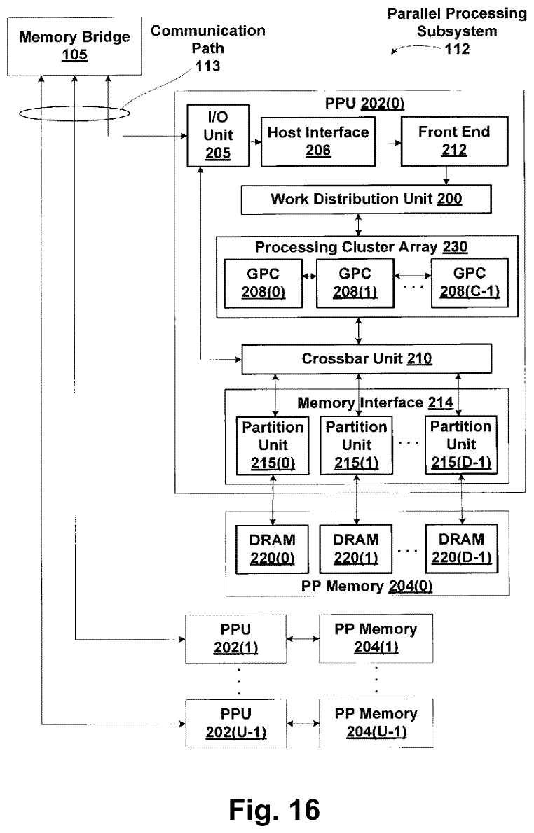

FIG. 16 illustrates an example parallel processing subsystem 112. As shown, parallel processing subsystem 112 includes one or more parallel processing units (PPUs) 202, each of which is coupled to a local parallel processing (PP) memory 204. In general, a parallel processing subsystem includes a number U of PPUs, where U>=1. PPUs 202 and parallel processing memories 204 may be implemented using one or more integrated circuit devices, such as programmable processors, application specific integrated circuits (ASICs), or memory devices, or in any other technically feasible fashion.

In some embodiments, some or all of PPUs 202 in parallel processing subsystem 112 are graphics processing units that may include rendering pipelines that can be configured to perform various tasks related to generating pixel data from graphics data supplied by CPU 102 and/or system memory 104 via memory bridge 105 and bus 113, interacting with local parallel processing memory 204 (which can be used as graphics memory including, e.g., a conventional frame buffer) to store and update pixel data, delivering pixel data to display device 110, and the like. In some embodiments, parallel processing subsystem 112 may include one or more PPUs 202 that operate as graphics processors and one or more other PPUs 202 that are used for general-purpose computations—or each PPU can be used either for graphics generation or for general-purpose computations as the need arises. The PPUs may be identical or different, and each PPU may have its own dedicated parallel processing memory device(s) or no dedicated parallel processing memory device(s). One or more PPUs 202 may output data to display device 110 or each PPU 202 may output data to one or more display devices 110.

In operation, CPU 102 is the master processor of computer system 100, controlling and coordinating operations of other system components. In particular, CPU 102 issues commands that control the operation of PPUs 202. In some embodiments, CPU 102 writes a stream of commands for each PPU 202 to a pushbuffer that may be located in system memory 104, parallel processing memory 204, or another storage location accessible to both CPU 102 and PPU 202. PPU 202 reads the command stream from the pushbuffer and then executes commands asynchronously relative to the operation of CPU 102.

Each PPU 202 includes an I/O (input/output) unit 205 that communicates with the rest of computer system 100 via communication path 113, which connects to memory bridge 105 (or, in one alternative embodiment, directly to CPU 102).

Each PPU 202 advantageously implements a highly parallel processing architecture. As shown in detail, PPU 202(0) includes a processing cluster array 230 that includes a number C of general processing clusters (GPCs) 208, where C>=1. Each GPC 208 is capable of concurrently executing a large number (e.g., hundreds or thousands) of threads concurrently, where each thread is an instance of a program. In various applications, different GPCs 208 may be allocated for processing different types of programs or for performing different types of computations. For example, in a graphics application, a first set of GPCs 208 may be allocated to perform tessellation operations and to produce primitive topologies for patches, and a second set of GPCs 208 may be allocated to perform tessellation shading and/or ray tracing to evaluate patch parameters for the primitive topologies and to determine vertex positions and other per-vertex attributes. In a compute application, a first set of GPCs 208 may be allocated to perform tensor operations for training or implementing a first neural network, while a second set of GPCs may be allocated to perform mathematical or tensor operations for training or implementing a second neural network. In a mixed compute and graphic application, some GPCs 206 may be allocated to perform graphics processing whereas other GPCs may be allocated to perform compute processing as described above. The possibilities are limited only by the imagination of the application programmer, and the allocation of GPCs 208 may vary dependent on the workload arising for each type of program or computation.

GPCs 208 receive processing tasks to be executed via a work distribution unit 200, which receives commands defining processing tasks from front end unit 212. Processing tasks include indices of data to be processed, e.g., surface (patch) data, primitive data, vertex data, and/or pixel data, and/or compute data such as matrices and other operands, as well as state parameters and commands defining how the data is to be processed (e.g., what program is to be executed). Work distribution unit 200 may be configured to fetch the indices corresponding to the tasks, or work distribution unit 200 may receive the indices from front end 212. Front end 212 ensures that GPCs 208 are configured to a valid state before the processing specified by the pushbuffers is initiated.

Memory interface 214 includes a number D of partition units 215 that are each directly coupled to a portion of parallel processing memory 204, where D>=1. As shown, the number of partition units 215 in one embodiment generally equals the number of DRAM 220. In other embodiments, the number of partition units 215 may not equal the number of memory devices. Persons skilled in the art will appreciate that DRAM 220 may be replaced with other suitable storage devices and can be of generally conventional design. Render targets, such as frame buffers or texture maps may be stored across DRAMs 220, allowing partition units 215 to write portions of each render target in parallel to efficiently use the available bandwidth of parallel processing memory 204.

In one embodiment, the architecture shown provides a unified memory architecture (UMA) providing a single or common memory address space accessible from any processor in a system. This hardware/software technology allows applications to allocate data that can be read or written from code running on either CPUs or GPUs. NVIDIA's CUDA® (Compute Unified Device Architecture) technology provides a C language environment that enables programmers and developers to write software applications to solve complex computational problems such as video and audio encoding, modeling for oil and gas exploration, and medical imaging. The applications are configured for parallel execution by a multi-core GPU and typically rely on specific features of the multi-core GPU. When code running on a CPU or GPU accesses CUDA managed data, the CUDA system software and/or the hardware takes care of proper memory accessing.

Thus, in one embodiment any one of GPCs 208 may process data to be written to any of the DRAMs 220 within parallel processing memory 204. Crossbar unit 210 is configured to route the output of each GPC 208 to the input of any partition unit 215 or to another GPC 208 for further processing. GPCs 208 communicate with memory interface 214 through crossbar unit 210 to read from or write to various external memory devices. In one embodiment, crossbar unit 210 has a connection to memory interface 214 to communicate with I/O unit 205, as well as a connection to local parallel processing memory 204, thereby enabling the processing cores within the different GPCs 208 to communicate with system memory 104 or other memory that is not local to PPU 202. In the embodiment shown in FIG. 16, crossbar unit 210 is directly connected with I/O unit 205. Crossbar unit 210 may use virtual channels to separate traffic streams between the GPCs 208 and partition units 215.

GPCs 208 can thus be programmed to execute processing tasks relating to a wide variety of applications, including but not limited to, linear and nonlinear data transforms, filtering of video and/or audio data, modeling operations (e.g., applying laws of physics to determine position, velocity and other attributes of objects), image rendering operations (e.g., tessellation shader, vertex shader, geometry shader, ray tracing, and/or pixel shader programs), Sequence to Sequence Models, neural networks of various kinds including Perceptrons, Feed Forward Neural Networks, Multilayer Perceptrons, Convolutional Neural Networks, Radial Basis Functional Neural Network, Recurrent Neural Networks, and LSTM—Long Short-Term Memory networks and so on. Such neural networks can be deep neural networks in some embodiments.

PPUs 202 may transfer data from system memory 104 and/or local parallel processing memories 204 (e.g., via L2 cache memories) into internal (on-chip) memory (L1 and L0 cache memories), process the data, and write result data back (e.g., via L2 cache memories) to system memory 104 and/or local parallel processing memories 204, where such data can be accessed by other system components, including CPU 102 or another parallel processing subsystem 112.

A PPU 202 may be provided with any amount of local parallel processing memory 204, including no local memory, and may use local memory and system memory in any combination. For instance, a PPU 202 can be a graphics processor in a unified memory architecture (UMA) embodiment. In such embodiments, little or no dedicated graphics (parallel processing) memory may be provided, and PPU 202 would use system memory almost exclusively. In UMA embodiments, a PPU 202 may be integrated into a bridge chip or processor chip or provided as a discrete chip with a high-speed link (e.g., PCI-EXPRESS) connecting the PPU 202 to system memory via a bridge chip or other communication means.

As noted above, any number of PPUs 202 can be included in a parallel processing subsystem 112. For instance, multiple PPUs 202 can be provided on a single add-in card, or multiple add-in cards can be connected to communication path 113, or one or more of PPUs 202 can be integrated into a bridge chip. PPUs 202 in a multi-PPU system may be identical to or different from one another. For instance, different PPUs 202 might have different numbers of processing cores, different amounts of local parallel processing memory, and so on. Where multiple PPUs 202 are present, those PPUs may be operated in parallel to process data at a higher throughput than is possible with a single PPU 202. Systems incorporating one or more PPUs 202 may be implemented in a variety of configurations and form factors, including desktop, laptop, or handheld personal computers, servers, workstations, game consoles, embedded systems, and the like.

### Processing Cluster Array Overview

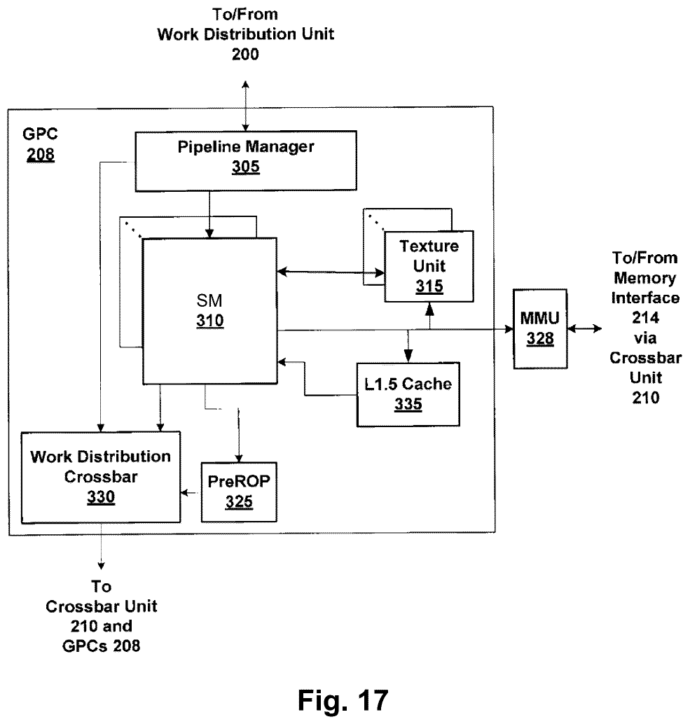

FIG. 17 is a block diagram of a GPC 208 within one of the PPUs 202 of FIG. 16, according to one embodiment. Each GPC 208 may be configured to execute a large number of threads in parallel, where the term “thread” refers for example to an instance of a particular program executing on a particular set of input data. In some embodiments, single-instruction, multiple-data (SIMD) instruction issue techniques are used to support parallel execution of a large number of threads without providing multiple independent instruction units. In other embodiments, single-instruction, multiple-thread (SIMT) techniques are used to support parallel execution of a large number of generally synchronized threads, using a common instruction unit configured to issue instructions to a set of processing engines within each one of the GPCs 208. Unlike a SIMD execution regime, where all processing engines typically execute identical instructions, SIMT execution allows different threads to more readily follow divergent execution paths through a given thread program. Persons skilled in the art will understand that a SIMD processing regime represents a functional subset of a SIMT processing regime.

Operation of GPC 208 is advantageously controlled via a pipeline manager 305 that distributes processing tasks to streaming multiprocessors (SMs) 310. Pipeline manager 305 may also be configured to control a work distribution crossbar 330 by specifying destinations for processed data output by SMs 310.

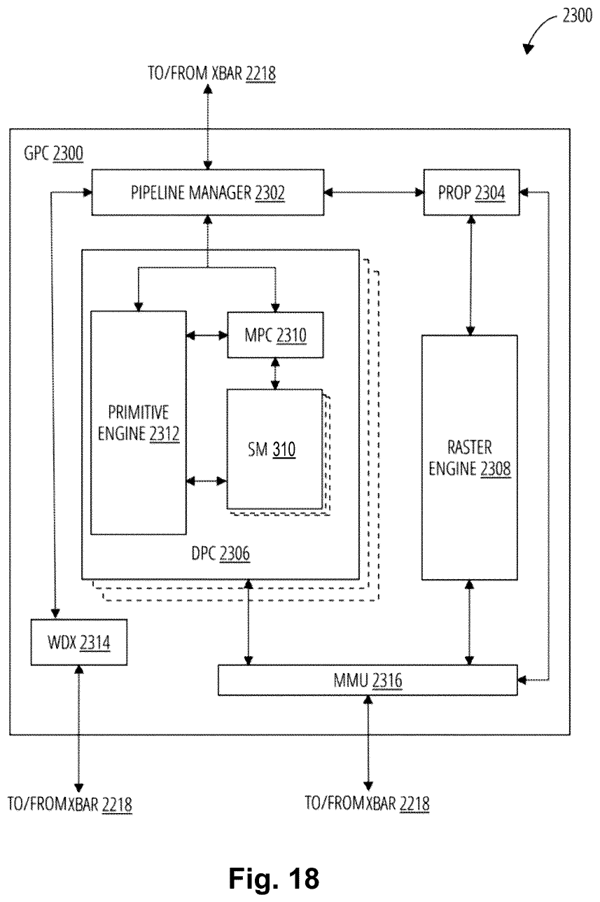

In one embodiment, each GPC 208 includes a number M of SMs 310, where M>=1, each SM 310 configured to process one or more thread groups. Also, each SM 310 advantageously includes an identical set of functional execution units (e.g., arithmetic logic units, and load-store units, shown as Exec units 302 and LSUs 303 in FIG. 15) that may be pipelined, allowing a new instruction to be issued before a previous instruction has finished, as is known in the art. Any combination of functional execution units may be provided. In one embodiment, the functional units support a variety of operations including integer and floating point arithmetic (e.g., addition and multiplication), comparison operations, Boolean operations (AND, OR, XOR), bit-shifting, and computation of various algebraic functions (e.g., planar interpolation, trigonometric, exponential, and logarithmic functions, etc.); and the same functional-unit hardware can be leveraged to perform different operations. In one example non-limiting embodiment, such functional execution units may comprise “streaming multiprocessors” or SMs as described above. Sec also FIG. 18 for another variation including multiple SMs and showing a raster operation (ROP) engine.

The series of instructions transmitted to a particular GPC 208 constitutes a thread, as previously defined herein, and the collection of a certain number of concurrently executing threads across the parallel processing engines (not shown) within an SM 310 is referred to herein as a “warp” or “thread group.” As used herein, a “thread group” refers to a group of threads concurrently executing the same program on different input data, with one thread of the group being assigned to a different processing engine within an SM 310. A thread group may include fewer threads than the number of processing engines within the SM 310, in which case some processing engines will be idle during cycles when that thread group is being processed. A thread group may also include more threads than the number of processing engines within the SM 310, in which case processing will take place over consecutive clock cycles. Since each SM 310 can support up to G thread groups concurrently, it follows that up to G*M thread groups can be executing in GPC 208 at any given time.

Additionally, a plurality of related thread groups may be active (in different phases of execution) at the same time within an SM 310. This collection of thread groups is referred to herein as a “cooperative thread array” (“CTA”) or “thread array.” The size of a particular CTA is equal to m*k, where k is the number of concurrently executing threads in a thread group and is typically an integer multiple of the number of parallel processing engines within the SM 310, and m is the number of thread groups simultaneously active within the SM 310. The size of a CTA is generally determined by the programmer and the amount of hardware resources, such as memory or registers, available to the CTA.

Each SM 310 contains an L1 cache or uses space in a corresponding L1 cache outside of the SM 310 that is used to perform load and store operations. Each SM 310 also has access to L2 caches within the partition units 215 as described above that are shared among all GPCs 208 and may be used to transfer data between threads. SMs 310 also have access to off-chip “global” memory, which can include, e.g., parallel processing memory 204 and/or system memory 104. It is to be understood that any memory external to PPU 202 may be used as global memory. Additionally, an L1.5 cache 335 may be included within the GPC 208, configured to receive and hold data fetched from memory via memory interface 214 requested by SM 310, including instructions, uniform data, and constant data, and provide the requested data to SM 310. Embodiments having multiple SMs 310 in GPC 208 beneficially share common instructions and data cached in L1.5 cache 335.

As noted above, each GPC 208 may include a memory management unit (MMU) 328 that is configured to map virtual addresses into physical addresses. In other embodiments, MMU(s) 328 may reside within the memory interface 214. The MMU 328 includes a set of page table entries (PTEs) used to map a virtual address to a physical address of a tile and optionally a cache line index. The MMU 328 may include address translation lookaside buffers (TLB) or caches which may reside within multiprocessor SM 310 or the L1 cache or GPC 208. The physical address is processed to distribute surface data access locality to allow efficient request interleaving among partition units. The cache line index may be used to determine whether or not a request for a cache line is a hit or miss.

In graphics and computing applications, a GPC 208 may be configured such that each SM 310 is coupled to a texture unit 315 for performing texture mapping operations, e.g., determining texture sample positions, reading texture data, and filtering the texture data. Texture data is read from an internal texture L1 cache (not shown) or in some embodiments from the L1 cache within SM 310 and is fetched from an L2 cache, parallel processing memory 204, or system memory 104, as needed. Each SM 310 outputs processed tasks to work distribution crossbar 330 in order to provide the processed task to another GPC 208 for further processing or to store the processed task in an L2 cache, parallel processing memory 204, or system memory 104 via crossbar unit 210. A preROP (pre-raster operations) 325 is configured to receive data from SM 310, direct data to ROP units within partition units 215, and perform optimizations for color blending, organize pixel color data, and perform address translations.

It will be appreciated that the core architecture described herein is illustrative and that variations and modifications are possible. Any number of processing units, e.g., SMs 310 or texture units 315, preROPs 325 may be included within a GPC 208. Further, while only one GPC 208 is shown, a PPU 202 may include any number of GPCs 208 that are advantageously functionally similar to one another so that execution behavior does not depend on which GPC 208 receives a particular processing task. Further, each GPC 208 advantageously operates independently of other GPCs 208 using separate and distinct processing units, L1 caches, and so on.

FIG. 19 is a block diagram of a partition unit 215 within one of the PPUs 202 of FIG. 16, according to one embodiment of the present invention. As shown, partition unit 215 includes a L2 cache 350, a frame buffer (FB) DRAM interface 355, and a raster operations unit (ROP) 360. As discussed above, L2 cache 350 is a read/write cache that is configured to perform load and store operations received from crossbar unit 210 and ROP 360. Read misses and urgent writeback requests are output by L2 cache 350 to FB DRAM interface 355 for processing. Dirty updates are also sent to FB 355 for opportunistic processing. FB 355 interfaces directly with DRAM 220, outputting read and write requests and receiving data read from DRAM 220.

In graphics applications, ROP 360 is a processing unit that performs raster operations, such as stencil, z test, blending, and the like, and outputs pixel data as processed graphics data for storage in graphics memory. In some embodiments of the present invention, ROP 360 is included within each GPC 208 instead of partition unit 215, and pixel read and write requests are transmitted over crossbar unit 210 instead of pixel fragment data.

Processed graphics data may be displayed on display device 110 or routed for further processing by CPU 102 or by one of the processing entities within parallel processing subsystem 112. Each partition unit 215 includes a ROP 360 in order to distribute processing of the raster operations. In some embodiments, ROP 360 may be configured to compress z or color data that is written to memory and decompress z or color data that is read from memory.

Persons skilled in the art will understand that the architecture shown in no way limits the scope of the present technology and that the techniques taught herein may be implemented on any properly configured processing unit, including, without limitation, one or more CPUs, one or more multi-core CPUs, one or more PPUs 202, one or more GPCs 208, one or more graphics or special purpose processing units, or the like, without departing from the scope of the present technology.

In embodiments, it is desirable to use PPU 122 or other processor(s) of a computing system to execute general-purpose computations using thread arrays. Each thread in the thread array is assigned a unique thread identifier (“thread ID”) that is accessible to the thread during its execution. The thread ID, which can be defined as a one-dimensional or multi-dimensional numerical value controls various aspects of the thread's processing behavior. For instance, a thread ID may be used to determine which portion of the input data set a thread is to process and/or to determine which portion of an output data set a thread is to produce or write.

A sequence of per-thread instructions may include at least one instruction that defines a cooperative behavior between the representative thread and one or more other threads of the thread array. For example, the sequence of per-thread instructions might include an instruction to suspend execution of operations for the representative thread at a particular point in the sequence until such time as one or more of the other threads reach that particular point, an instruction for the representative thread to store data in a shared memory to which one or more of the other threads have access, an instruction for the representative thread to atomically read and update data stored in a shared memory to which one or more of the other threads have access based on their thread IDs, or the like. The CTA program can also include an instruction to compute an address in the shared memory from which data is to be read, with the address being a function of thread ID. By defining suitable functions and providing synchronization techniques, data can be written to a given location in shared memory by one thread of a CTA and read from that location by a different thread of the same CTA in a predictable manner.

Consequently, any desired pattern of data sharing among threads can be supported, and any thread in a CTA can share data with any other thread in the same CTA. The extent, if any, of data sharing among threads of a CTA is determined by the CTA program; thus, it is to be understood that in a particular application that uses CTAs, the threads of a CTA might or might not actually share data with each other, depending on the CTA program, and the terms “CTA” and “thread array” are used synonymously herein.

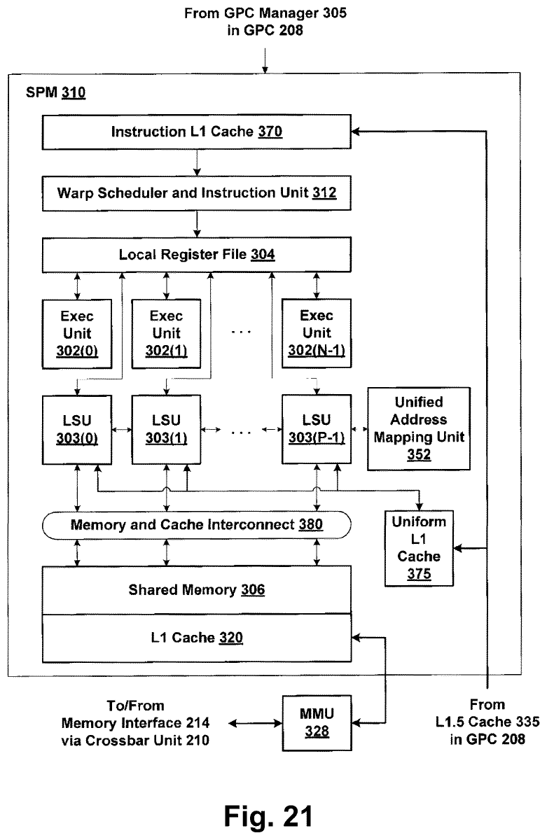

FIG. 21 is a block diagram of an SM 310, according to one embodiment. The SM 310 includes an instruction L1 cache 370 that is configured to receive instructions and constants from memory via L1.5 cache 335. A warp scheduler and instruction unit 312 receives instructions and constants from the instruction L1 cache 370 and controls local register file 304 and SM 310 functional units according to the instructions and constants. The SM 310 functional units include N exec (execution or processing) units 302 and P load-store units (LSU) 303.

SM 310 provides on-chip (internal) data storage with different levels of accessibility. Special registers (not shown) are readable but not writeable by LSU 303 and are used to store parameters defining each CTA thread's “position.” In one embodiment, special registers include one register per CTA thread (or per exec unit 302 within SM 310) that stores a thread ID; each thread ID register is accessible only by a respective one of the exec unit 302. Special registers may also include additional registers, readable by all CTA threads (or by all LSUs 303) that store a CTA identifier, the CTA dimensions, the dimensions of a grid to which the CTA belongs, and an identifier of a grid to which the CTA belongs. Special registers are written during initialization in response to commands received via front end 212 from device driver 103 and do not change during CTA execution.

A parameter memory (not shown) stores runtime parameters (constants) that can be read but not written by any CTA thread (or any LSU 303). In one embodiment, device driver 103 provides parameters to the parameter memory before directing SM 310 to begin execution of a CTA that uses these parameters. Any CTA thread within any CTA (or any exec unit 302 within SM 310) can access global memory through a memory interface 214. Portions of global memory may be stored in the L1 cache 320.

Local register file 304 is used by each CTA thread as scratch space; each register is allocated for the exclusive use of one thread, and data in any of local register file 304 is accessible only to the CTA thread to which it is allocated. Local register file 304 can be implemented as a register file that is physically or logically divided into Planes, each having some number of entries (where each entry might store, e.g., a 32-bit word). One lane is assigned to each of the N exec units 302 and P load-store units LSU 303, and corresponding entries in different lanes can be populated with data for different threads executing the same program to facilitate SIMD execution. Different portions of the lanes can be allocated to different ones of the G concurrent thread groups, so that a given entry in the local register file 304 is accessible only to a particular thread. In one embodiment, certain entries within the local register file 304 are reserved for storing thread identifiers, implementing one of the special registers.

Shared memory 306 is accessible to all CTA threads (within a single CTA); any location in shared memory 306 is accessible to any CTA thread within the same CTA (or to any processing engine within SM 310). Shared memory 306 can be implemented as a shared register file or shared on-chip cache memory with an interconnect that allows any processing engine to read from or write to any location in the shared memory. In other embodiments, shared state space might map onto a per-CTA region of off-chip memory, and be cached in L1 cache 320. The parameter memory can be implemented as a designated section within the same shared register file or shared cache memory that implements shared memory 306, or as a separate shared register file or on-chip cache memory to which the LSUs 303 have read-only access. In one embodiment, the area that implements the parameter memory is also used to store the CTA ID and grid ID, as well as CTA and grid dimensions, implementing portions of the special registers. Each LSU 303 in SM 310 is coupled to a unified address mapping unit 352 that converts an address provided for load and store instructions that are specified in a unified memory space into an address in each distinct memory space. Consequently, an instruction may be used to access any of the local, shared, or global memory spaces by specifying an address in the unified memory space.

The L1 Cache 320 in each SM 310 can be used to cache private per-thread local data and also per-application global data. In some embodiments, the per-CTA shared data may be cached in the L1 cache 320. The LSUs 303 are coupled to a uniform L1 cache 371, the shared memory 306, and the L1 cache 320 via a memory and cache interconnect 380. The uniform L1 cache 371 is configured to receive read-only data and constants from memory via the L1.5 Cache 335.

FIG. 19 shows another view of an SM 310 as a streaming multiprocessor including an L1 instruction cache, an L0 instruction cache, a warp scheduler, a dispatcher unit, a register file (which may comprise shared memory in some implementations that is accessible by other SMs), and a number of processing cores including fixed point cores, floating point cores of different precisions, and tensor cores. Load/store circuits interface the processing cores with a data cache that may comprise shared memory as well as to texture memory. A crossbar may connect the SM to an L2 cache memory (and thus to the memory system including main memory). As can be seen, a processing core within the SM that is executing a thread may communicate with an MSEC 3000 in the L2 cache memory 2404 by writing a command over a memory interface for example.

As FIG. 19 shows, each SM 2000 has its own instruction schedulers 2504 and various instruction execution pipelines 2510, 2512, 2514. For Compute functionality, multiply-add is the most frequent operation in modern neural networks, acting as a building block for fully-connected and convolutional layers, both of which can be viewed as a collection of vector dot-products. Floating point operations can be executed in either Tensor Cores or NVIDIA CUDA® cores. Furthermore, the architecture can execute integer operations in either Tensor Cores or CUDA cores. Tensor Cores were introduced in the NVIDIA Volta™ GPU architecture to accelerate matrix multiply and accumulate operations for machine learning and scientific applications. These instructions operate on small matrix blocks (for example, 4×4 blocks). Note that Tensor Cores can compute and accumulate products in higher precision than the inputs. When math operations cannot be formulated in terms of matrix blocks, they are executed in other CUDA cores. For example, the element-wise addition of two half-precision tensors would generally be performed by CUDA cores, rather than Tensor Cores.

To utilize their parallel resources, GPUs execute many threads concurrently. There are two concepts helpful to understanding how thread count relates to GPU performance in some example embodiments:
GPUs execute functions using a multi-level hierarchy of threads. A given function's threads are grouped into equally-sized thread blocks, and a set of thread blocks are launched to execute the function.
GPUs hide dependent instruction latency by switching to the execution of other threads. Thus, the number of threads used to effectively utilize a GPU is generally much higher than the number of cores or instruction pipelines.

### Hierarchical Memory Addressing

A GPU cluster comprising two or more GPUs may be coupled directly together via a local interconnect, or via the memory bridge 105, as shown in FIG. 16. A GPU cluster comprising a plurality of GPUs may also be coupled together using a commodity networking interface, such as the well-known Infiniband interface. In one embodiment, each GPU incorporates an Infiniband interface, for example as part of the I/O unit 205. In alternate embodiments, the memory bridge 105 incorporates an Infiniband interface, enabling GPUs coupled to one instance of the memory bridge 105 to communicate with GPUs coupled to another instance of the memory bridge 105.

In one embodiment, each GPU includes a set of seven “GPU-links” that permit glue-less composition of multi-GPU systems with two, four, or eight GPUs. In a two-node system, all seven links are connected between the two GPUs. In a four-node system, two links are connected to GPUs i+1 and i+3, and three links are connected to GPU i+2. In an eight GPU system, one link is connected between each pair of GPUs. The GPU links should be sized so that the aggregate GPU-link bandwidth is approximately one fourth the local bandwidth for a locally attached DRAM. The GPU-links are configured using any technically feasible technique to carry both memory traffic (read- and write-request and reply packets in granularities from one word to one cache line) and active messages.

Each GPU in a GPU cluster is assigned a portion of the unified address space that is shared and consistent across all GPUs within the GPU cluster. The unified address space may be extended to include one or more CPUs coupled to the GPU cluster. Topology information may be transmitted to each GPU, for example, as part of an address space assignment. In one embodiment, the one or more CPUs perform topology discovery and assign topology information to each GPU within the GPU cluster. Alternatively, each GPU may independently perform topology discovery.

The unified address space includes local memory and cache circuits within each GPU. Each memory and cache circuit within the unified address space is configured to be accessible by every GPU within the GPU cluster. In one embodiment, coherence and consistency are provided across the unified address space.

In one embodiment, the memory management subsystem within a given GPU is configured to perform block transfers between local memory circuits associated with the GPU and arbitrary regions of the unified address space. The block transfers may comprise fetching records with unit stride, arbitrary stride, gather/scatter operations, and copying operations. The arbitrary regions may comprise a hierarchy of distributed memory circuits within one or more other GPUs, local memory attached to the one or more other GPUs, dedicated memory subsystems, or any combination thereof. In one embodiment, each block associated with a block transfer comprises at least a portion of a cache line, and the memory management subsystem initiates a transfer when a corresponding element of a cache line is accessed locally by an associated GPU.

For cacheable data, any read to a shared variable should return the most recent write to that variable. To ensure coherence, a directory may be maintained for every mutable line of memory that can potentially be shared in multiple caches. The address of the line uniquely identifies the location of the directory in global memory. The directory records a current state for the line, including, without limitation, an exclusive or shared status, an owner of the line, and a list of sharers. A hierarchical addressing scheme is implemented for accessing the unified address space. In one embodiment, the unified address space is accessed via an addressing scheme that specifies a level of the hierarchy along with a path from an address space root to an addressed location, as illustrated in greater detail below in FIG. 16.

FIG. 22 illustrates an address encoding technique for uniquely locating data within a hierarchical GPU cluster, according to one embodiment of the present invention. As shown, a hierarchical address 405 comprises a level field 410 and a path field 420. The level field 410 indicates a level within a hierarchy of distributed memory circuits (“memory hierarchy”) comprising the hierarchical GPU cluster where target data is located. The path field 420 is interpreted based on the level field 410. In one embodiment, a level field 410 value of “O” indicates the top of the memory hierarchy, which represents a global address space. The global address space maps to a first portion of the unified address space. A level field 410 value of “4” indicates the bottom of the memory hierarchy, which may correspond to a data location residing within a local memory circuit within a specific GPU.

If the level field 410 is equal to “0,” then the path field 420 comprises a global address 428 associated with the top level of the memory hierarchy. If the level field is equal to “1,” then the path field 420 is interpreted as having a node identification (ID) field 430, and a local node address field 438. The node ID field 430 identifies a specific GPU within the hierarchical GPU cluster. Each GPU identified by a node ID field 430 includes a unique local node address space, which may be addressed via the local node address field 441.

If the level field 410 is equal to “2,” then the path field 420 is interpreted as having a node ID field 430, a level three (L3) address identifier (ID) field 432, and a level three (L3) address field 442. Each unique combination of values for the node ID field 430 and the L3 ID field 432 represents one unique address space, which may be addressed via the L3 address field 442.

If the level field 410 is equal to “3,” then the path field 420 is interpreted as having a node ID field 430, an L3 ID field 432, a level two (L2) identifier (ID) field 434, and an L2 address field 434. Each unique combination of values for the node ID field 430, the L3 ID field 432, and L2 ID field 434 represents one unique address space, which may be addressed via the L2 address field 443.

If the level field 410 is equal to “4,” then the path field 420 is interpreted as having a node ID field 430, an L3 ID field 432, an L2 ID field 434, a level one (L1) identifier (ID) field 436, and an L1 address field 444. Each unique combination of values for the node ID field 430, L3 ID field 432, L2 ID field 434, and L1 ID field 436 represents one unique address space, which may be addressed via the L1 address field 444.

In one embodiment, the level field 410 is left justified (located within a set of most significant bits) within the hierarchical address 405 and the node ID 430 is left justified next to the level field 410. Furthermore, the global address 428, local node address 441, L3 address 442, L2 address 443, or L1 address 444 are right justified (located within a set of least significant bits) within the hierarchical address 405.

The global address field 428 and each combination of values for the node ID field 430 through L1 ID field 436 represents a unique address space within the unified address space. Each unique address space corresponds to a particular memory circuit located in one GPU within the GPU cluster. In this way, the hierarchical address 405 may uniquely address data within any memory circuit located within any GPU within the GPU cluster. A special encoding for “here” may be used to replace any element of the path. For example, a field comprising all “1” values may indicate that the target location is local. Any technically feasible technique may be implemented to consistently enumerate the unique address spaces identified within the unified address space.

In the above example, five levels are identified within the hierarchical address 405, including a global, node, and three on-chip levels. In one embodiment, six levels of hierarchy are identified within the hierarchical address 405, including a global, node, and four on-chip levels. The node ID field comprises 16-bits and each local node address 441 comprises 38 bits. In such an embodiment, 57 virtual address bits are implemented. A 64-bit virtual address may be implemented to include 57 bits, with level and node left aligned and the remainder of the address bits right aligned. Some address bits in the middle need not be interpreted.

A particular physical memory location can be used as an explicitly managed local memory or as a cache for higher levels of the hierarchy. In one embodiment, local memory, such as DRAM coupled to a given GPU, may be divided between global address space and local address space. The GPU provides configuration registers to enable storage at each level of the hierarchy to be divided between cache and explicitly-managed storage. One approach is to allow each “way” of each local memory to be configured as a cache or as an explicitly managed local memory. An alternative implementation divides each storage level by index address into a cache slice and an explicitly managed slice.

A local memory configured to perform as a cache can store lines with addresses from any level above that is in a cacheable address space. For example, an L2 cache can cache explicit L3 addresses, node addresses, and global addresses. However, the L2 cache may not be able to cache L3 addresses from a different node address.

A node ID having all “1” values at any position in the path field 420 specifies the current location (H or here). The tree representing the hierarchy of the GPU cluster need not be uniform.

Different caches at the same level may be different sizes and leaves of the tree may occur at different depths. For example, consider a combined GPU/CPU system where the CPU and the GPU share a “last-level” on-chip cache (level 2). In such a system, the CPU may have only a single level of cache below, meaning its leaf cache is at level 3, while the GPU may have two levels, meaning its leaves are at level 4. Programs executing on a GPU or CPU should be configured to have access to a tree structure that specifies size and depth to match program requirements to non-uniform trees. In the example embodiments herein, a programmable memory shader execution circuit may be placed at any level of this memory hierarchy, e.g., at the L1 shared memory level or at any desired level of coherence in the memory hierarchy.

To handle distribution of data up and down the hierarchy, the set of places that can be specified should be hierarchical so that at lower levels of the hierarchy one can specify not just the node, but the memory within the node (e.g., the shared memory on a particular SM). This is used to provide for persistent hierarchical memory (i.e., data in lower levels of the memory hierarchy that persists over multiple CTAs). Persistent hierarchical memory may be critical to exploit higher levels of explicitly-managed on-chip memory since time constants associated with all but the bottom level will be longer than the lifetime of a single CTA. Supporting explicitly-managed memory at multiple levels may be helpful because it can reduce external memory bandwidth demand by a large factor, effectively multiplying the bandwidth of external memory. To provide for efficient execution, the programmer should be able to specify affinity between a thread or CTA and a portion of the hierarchical memory space. Any technically feasible technique may be implemented to explicitly manage memory and to specify thread (or CTA) affinity to a portion of the hierarchical memory space.

To facilitate virtualization, each local memory in the hierarchy should have one or more mapping registers that specify which node (or nodes) of a virtual hierarchy they hold. Tasks may also have a location register specifying which leaf node they are associated with. A task register may be used to replace the “here” fields of relative addresses with absolute node numbers at each level. If the fields match the local memory, then access is made locally, otherwise a search procedure is followed to find the current version of requested data.

In one embodiment, backing storage is provided for each local memory in global memory. The global memory represents a fall-back location for a local memory if it is not currently mapped into a local memory. The backing storage also facilitates running virtual hierarchies that are larger than the physical hierarchy.

Per line valid information may be used to allow for soft relocation of local memories. If a task is moved and its local memory relocated with it, the task can bring the contents of the local memory in on demand—either from the old location for the data or from a backing store residing in local memory.

### Example Use Cases & Systems

The techniques disclosed herein may be incorporated in any processor that may be used for processing a neural network such as, for example, a central processing unit (CPU), a graphics processing unit (GPU), an intelligence processing unit (IPU), neural processing unit (NPU), tensor processing unit (TPU), neural network processor (NNP), a data processing unit (DPU), a vision processing unit (VPU), an application specific integrated circuit (ASIC), a field-programmable gate array (FPGA), and the like. Such a processor may be incorporated in a personal computer (e.g., a laptop), at a data center, in an Internet of Things (IOT) device, a handheld device (e.g., smartphone), a vehicle, a robot, or any other device that performs inference, training or any other processing of a neural network. Such a processor may be employed in a virtualized system such that an operating system executing in a virtual machine on the system can utilize the processor.

As an example, a processor incorporating the techniques disclosed herein can be employed to process one or more neural networks in a machine to identify, classify, manipulate, handle, operate, modify, or navigate around physical objects in the real world. For example, such a processor may be employed in an autonomous vehicle (e.g., an automobile, motorcycle, helicopter, drone, plane, boat, submarine, delivery robot, etc.) to move the vehicle through the real world. Additionally, such a processor may be employed in a robot at a factory to select components and assemble components into an assembly.

As an example, a processor incorporating the techniques disclosed herein can be employed to process one or more neural networks to identify one or more features in an image or to alter, generate, or compress an image. For example, such a processor may be employed to enhance an image that is rendered using raster, ray-tracing (e.g., using NVIDIA RTX), and/or other rendering techniques. In another example, such a processor may be employed to reduce the amount of image data that is transmitted over a network (e.g., the Internet, a mobile telecommunications network, a WIFI network, as well as any other wired or wireless networking system) from a rendering device to a display device. Such transmissions may be utilized to stream image data from a server or a data center in the cloud to a user device (e.g., a personal computer, video game console, smartphone, other mobile device, etc.) to enhance services that stream images such as NVIDIA Geforce Now (GFN), Google Stadia, and the like.

As an example, a processor incorporating the techniques disclosed herein can be employed to process one or more neural networks for any other types of applications that can take advantage of a neural network. For example, such applications may involve translating from one spoken language to another, identifying and negating sounds in audio, detecting anomalies or defects during production of goods and services, surveillance of living and/or non-living things, medical diagnosis, decision making, and the like.

As an example, a processor incorporating the techniques disclosed herein can be employed to implement neural networks such as large language models (LLMs) to generate content (e.g., images, video, text, essays, audio, and the like), respond to user queries, solve problems in mathematical and other domains, and the like.

It should be noted that the term “critical section” is not meant to state or imply what is or is not “critical” to claimed subject matter (to the contrary, each claim is to be read as a whole). Rather, the term “critical section” is a term of art in computer science fields that is not a disclaimer of subject matter and has nothing to do with anything being “critical” to legal claim scope, claim coverage, claim interpretation or the structure and operation of the present technology.

All patents and publications cited herein are expressly incorporated by reference for purposes of background and enablement but should not be used or applied as a basis for disclaiming subject matter.

1. In a computing system comprising concurrently executing parallel processors connected to access a memory, a programmable atomic memory shader execution circuit configured to perform programmable atomic processes on locked locations in the memory, the programmable atomic memory shader execution circuit comprising:
an input register,
an instruction store,
a data store, and
a programmable processor operatively coupled to the input register, the instruction store, and the data store;
wherein the instruction store and/or the data store comprise part of the memory.

2. The programmable atomic memory shader execution circuit of claim 1 wherein the memory comprises a cache memory and the data store comprises a cache line stored in the cache memory.

3. The programmable atomic memory shader execution circuit of claim 1 wherein the input register comprises a field specifying a size of a portion of the memory to lock while performing an atomic process.

4. The programmable atomic memory shader execution circuit of claim 1 wherein the parallel processors include a first processor configured to access the memory and a second processor configured to access the memory, wherein the first and second processors are each configured to command the programmable processor to execute atomic processes on the memory.

5. The programmable atomic memory shader execution circuit of claim 1 wherein the programmable processor is configured to execute memory shader instructions the memory stores in response to a memory shader selection field of the input register.

6. The programmable atomic memory shader execution circuit of claim 1 wherein the parallel processors are each configured to write arguments into the input register, the programmable processor using the arguments to execute atomic processes.

7. The programmable atomic memory shader execution circuit of claim 1 wherein the input register is configured as a return register to return status information to a calling parallel processor.

8. The programmable atomic memory shader execution circuit of claim 1 wherein the programmable processor is configured to execute lockless atomic operations and the memory provides hardware-based memory location locking and unlocking in response to signals the programmable processor generates.

9. The programmable atomic memory shader execution circuit of claim 1 wherein the programmable processor is disposed near to the memory.

10. The programmable atomic memory shader execution circuit of claim 1 wherein the programmable atomic memory shader execution circuit is selectable by memory address and has exclusive control of a subset of memory that contains the locations in the memory.

11. In a computing system comprising a first processor and a second processor concurrently executing threads, the first processor and the second processor each connected to a cache memory storing at least one cache line, a programmable processor configured to execute an atomic process on a variable length subset of the cache line, the variable length subset specified by a calling one of the first processor and the second processor.

12. The programmable processor of claim 11 wherein at least one of the first processor and the second processor provides some or all memory shader program instructions and/or arguments and/or operands and/or mode selectors to the programmable processor for use in executing memory shader functionality.

13. A method of performing an atomic operation comprising:
prestoring a memory shader in a memory accessible by each of plural processing cores;
sending, from at least one processing core to a programmable processor close to the memory, data indicating memory locations of the memory to operate upon atomically with the memory shader;
locking the indicated memory locations of the memory; and
then, executing the memory shader with the programmable processor to atomically operate on the locked indicated memory locations of the memory without releasing the lock on the locked indicated memory locations of the memory until after atomic operating is complete.

14. The method of claim 13 wherein data indicating the memory locations of the memory specifies a portion of a cache line stored in the memory.

15. The method of claim 13 further including registerizing the memory locations of the memory to thereby enable the programmable processor to access the registerized memory locations without needing to generate full memory addresses to address the memory locations.

16. The method of claim 13 further comprising:
sending, to the programmable processor close to the memory, information that enables the programmable processor to select between plural memory shaders prestored in the memory.

17. The method of claim 13 further comprising repeating sending, locking and executing with another processing core.

18. The method of claim 17 wherein the repeating comprises the programmable processor pipelining memory shader execution for atomic operation commands from plural processing cores.

19. The method of claim 17 wherein the repeating comprises the programmable processor coalescing atomic operations requested by plural processing cores.

20. The method of claim 17 further comprising replacing hardware-based atomic operations with said memory shader execution.

21. The method of claim 13 further including 1 using hardware controllable by the programmable processor to lock the memory locations of the memory.

22. The method of claim 13 further including returning a report to the processing core once atomic operating is complete.

23. The method of claim 13 further including stalling execution of a shader due to locked memory overlap with a currently executing shader.

24. The method of claim 13 wherein the at least one processing core provides some or all memory shader program inline instructions and/or arguments and/or operands and/or mode selectors to the programmable processor for use in executing memory shader functionality.

25. The method of claim 13 wherein the programmable processor has exclusive control of a subset of memory that contains the indicated locations of the memory, the method further including selecting the programmable processor based on the data indicating memory locations of the memory.
